(19) United States
(12) Patent Application Publication
(10) Pub. No.: US 2017/0199817 A1
(43) Pub. Date: Jul. 13, 2017

(54) DATA STORAGE DEVICE, DATA STORAGE METHOD, AND NON-TRANSITORY COMPUTER READABLE MEDIUM

(71) Applicant: KABUSHIKI KAISHA TOSHIBA, Tokyo (JP)

(72) Inventors: Takeshi ISHIHARA, Yokohama (JP); Takahiro YAMAURA, Kawasaki (JP); Kensaku YAMAGUCHI, Kawasaki (JP); Yuichiro OYAMA, Tokyo (JP); Yuta KOBAYASHI, Kawasaki (JP); Eimi MURAKAMI, Tokyo (JP)

(21) Appl. No.: 15/265,115

(22) Filed: Sep. 14, 2016

(30) Foreign Application Priority Data
Jan. 8, 2016 (JP) 2016-002751

(51) Int. Cl. G06F 12/0804; G06F 12/0868

(52) U.S. Cl. CPC G06F 12/0804; G06F 12/0868; G06F 2212/1041; G06F 2212/608

(57) ABSTRACT

According to one embodiment, a data storage device includes: a first hardware storage device; a second hardware storage device in which write is done by an integer multiple size of a predetermined size. The data storage device writes data into the first hardware storage device in response to a write instruction of data having expiration information. The data storage device manages data management information including: the expiration information of data written into the first hardware storage device; and a storage location of the data. The data storage device selects, when a predetermined condition is satisfied, a plurality of pieces of data in the first hardware storage device based on temporal proximity among pieces of the expiration information, reads out the pieces of data from the first hardware storage device, and writes the pieces of data into the second hardware storage device.

### CROSS-REFERENCE TO RELATED APPLICATIONS

This application is based upon and claims the benefit of priority from Japanese Patent Application No. 2016-002751, filed on Jan. 8, 2016; the entire contents of which are incorporated herein by reference.

### FIELD

An embodiment described herein relates to a data storage device, a data storage method, and a non-transitory computer readable medium.

### BACKGROUND

A cache system for temporarily storing data acquired via a network is widely used. For example, a technique for temporarily storing the data at the time of browsing a website is widely used as a web cache technique. In general, data on information provided via a website is retained together with an expiration date. In existing web cache techniques, a mechanism for managing the validity of the temporarily stored data with the expiration date.

When data is stored in NVMe which is a standard for connecting an SSD by PCI Express, a mechanism for notifying characteristics of data to be stored is implemented. The characteristics described herein refer to “data read/write frequency”. The use of this mechanism enables a storage device, such as an SSD, to execute processes based on the characteristics of the data to be stored (for example, data read frequency is high; data write frequency is high; data read and write frequencies are high; or data read and write frequencies are low). However, the contents of the processes are not specified and are implementation-dependent.

Furthermore, a storage device is disclosed which receives information about a data retention time requested by an application and changes a data encoding method and a threshold (when a cell deals with multiple levels) for electric charge of a cell which retains data wherein read from the cell is performed based on comparison the threshold and the electric charge of the cell.

As described above, the technique for managing the expiration date for information on a network and the technique for changing processes depending on the data retention period in the storage device are disclosed. However, the storage device which utilizes the expiration date included in the information on the network has not been implemented. As a result, in a cache technique for temporarily storing and distributing data on a network, temporal storage of the data in consideration of the operational characteristics (such as, a data read speed, a data write speed, and durability of an information storage cell) of the storage device has not been implemented, which impairs the advantage of the storage device.

More specifically, a status in which pieces of data having different expiration dates coexist in a unit capable of efficiently reading and writing data occurs in the storage device. Accordingly, when data with a long expiration date and data with a short expiration date coexist in the unit, if the data with a short expiration date is to be deleted from the storage device and another data is to be stored in the storage device, an overhead, such as saving of the data with a long expiration date in another area, occurs. Particularly when there is an upper limit of the number of rewrite cycles of a storage element, the overhead increases the number of rewrite cycles of the storage element beyond necessity, which results in shortening of the lifetime of the storage device.

### BRIEF DESCRIPTION OF THE DRAWINGS

FIG. 1 is a block diagram showing a cache device as a data storage device according to a first embodiment;

FIG. 2 is a schematic diagram showing a network system including the cache device shown in FIG. 1;

FIG. 3 is a diagram showing an example of a first method for implementing the management of cache data management information;

FIG. 4 is a diagram showing a second method for implementing the management of the cache data management information;

FIG. 5 is a diagram showing an example in which a table is divided into a plurality of sections;

FIG. 6 is a diagram showing an example in which a normalized expiration date is applied to the method shown in FIGS. 3A and 3B;

FIG. 7 is a diagram showing an example in which the normalized expiration date is applied to the method shown in FIG. 4;

FIG. 8 is a diagram showing an example in which storage of data in a ring buffer is implemented;

FIG. 9 is a diagram showing an example in which the ring buffer is updated;

FIG. 10 is a diagram showing an example in which a storage area is divided into two areas to be managed;

FIG. 11 is a diagram showing an example in which device management information is managed in one area;

FIG. 12 is a diagram showing an example in which a storage area is divided into a plurality of areas to be managed;

FIG. 13 is a diagram showing an example of a function for calculating an evaluation value;

FIG. 14 is a flowchart showing an overall operation of a nonvolatile storage of the first embodiment;

FIG. 15 is a flowchart showing an example of an operation flow when a read instruction is received in step S105 of FIG. 14;

FIG. 16 is a flowchart showing an example of an operation flow when a write instruction is received in step S104 of FIG. 14;

FIG. 17 is a flowchart showing an example of an operation flow of a normalization process;

FIG. 18 shows an example of an operation flow of a process of determining a storage location when data is stored in a volatile storage device;

FIG. 19 is flowchart showing an example of an operation in step S305 of FIG. 16;

FIG. 20 is a flowchart showing an example of an operation flow of a process of writing data into a nonvolatile storage device;

FIG. 21 is a sequence diagram according to the first embodiment;

FIG. 22 is a sequence diagram following FIG. 21;

FIG. 23 is a sequence diagram according to a second embodiment;

FIG. 24 is a sequence diagram following FIG. 23;

FIG. 25 is a diagram showing a modified example of the sequence shown in FIG. 23;

FIG. 26 is a block diagram showing a cache device as a data storage device according to a third embodiment; and

FIG. 27 is a sequence diagram according to the third embodiment.

### DETAILED DESCRIPTION

According to one embodiment, a data storage device includes: a first hardware storage device; a second hardware storage device in which write is done by an integer multiple size of a predetermined size.

The data storage device writes the data into the first hardware storage device in response to a write instruction of data having expiration information.

The data storage device manages data management information including: the expiration information of data written into the first hardware storage device; and a storage location of the data.

The data storage device selects, when a predetermined condition is satisfied, a plurality of pieces of data in the first hardware storage device based on temporal proximity among pieces of the expiration information, reads out the pieces of data from the first hardware storage device, and writes the pieces of data into the second hardware storage device.

Embodiments according to the present invention will be described below with reference to the drawings. One feature of the embodiments of the present invention is that data which is stored on a network together with an expiration date is temporarily stored in a cache device for redistribution of the data, and the cache device executes a process of storing the data utilizing the temporal proximity between expiration dates. More specifically, a plurality of pieces of data with close expiration dates are put together and stored. Thus, the pieces of data with close expiration dates are put together and stored, which leads to a reduction in overhead associated with the storage of data. Further, the overhead when the expired data is deleted from the storage device or the data is managed can be reduced. Consequently, the number of rewrite cycles of each storage element (cell or unit) can be reduced, and thus the durability of the storage device can be improved.

### First Embodiment

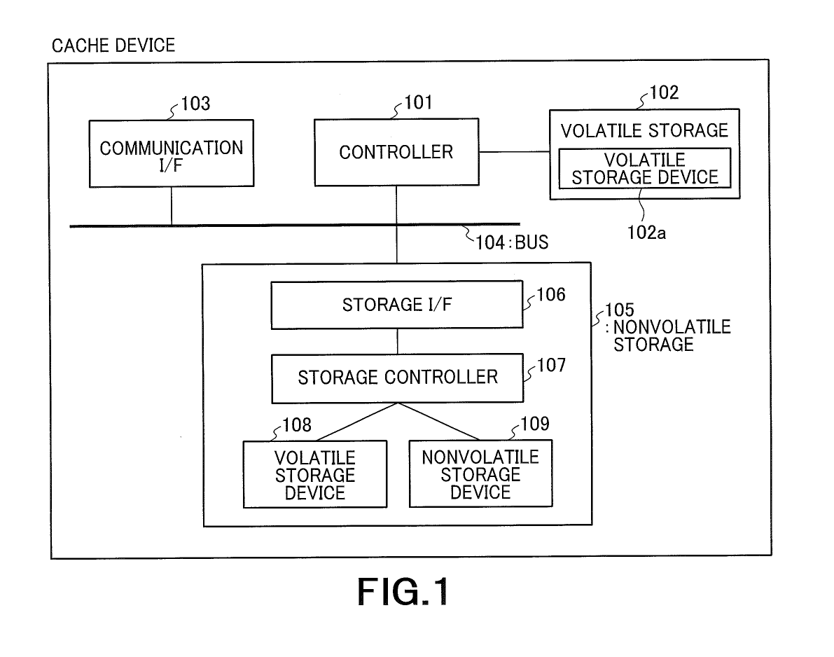

FIG. 1 is a block diagram showing a cache device as a data storage device according to an embodiment of the present invention. In FIG. 1, the illustration of parts which are not significantly associated with the operation of the present invention is omitted, and thus not all the components necessary for the cache device are illustrated.

The cache device shown in FIG. 1, which is a data storage device according to the embodiment, includes a controller 101, a volatile storage 102, a communication I/F 103, a bus 104, and a nonvolatile storage 105. These elements are appropriately connected via the bus 104 such as PCI Express or a memory bus. The volatile storage 102 is directly connected to the controller 101 not via the bus 104, but instead may be connected to the controller 101 via the bus 104.

The communication I/F 103 is a communication interface or communication circuitry for connecting to a network. For example, the communication I/F 103 communicates with another device via the network in accordance with a predetermined communication protocol, to thereby transmit and receive information. The network may be a wired network or a wireless network. Any standards, for example, wireless LAN (Local Area Network) standards, such as the IEEE802.11 standards, and Bluetooth®, may be used as the predetermined communication protocol.

The controller 101 is controlling circuitry to control the overall operation of the cache device. The controller 101 functions as a cache that temporarily stores information acquired from the network, or data included in the information, into the volatile storage 102 or the nonvolatile storage 105, and retransmits requested data when a new request for acquiring data is received from the network. A program or the like for implementing this function is operated by a processor, thereby implementing the function of the controller 101. The controller 101 is implemented as, for example, a processor or a computer for executing the program. The controller 101 may be composed of a plurality of processors.

The volatile storage 102 includes a volatile storage device 102a which is a hardware storage device. The volatile storage device 102a stores a program defining the operation of the controller 101, and information used for the operation of the program. The volatile storage device 102a may store information temporarily generated when the program is operated. Instead of the volatile storage 102, a nonvolatile storage including a nonvolatile device may be used.

The nonvolatile storage 105 is a storage capable of storing a larger number of pieces of information than that of the volatile storage 102 for a long period of time.

The nonvolatile storage 105 includes a storage I/F 106, a storage controller 107, a volatile storage device 108, and a nonvolatile storage device 109.

The storage I/F 106 is a hardware interface for connecting to the bus 104.

The storage controller 107 is storage controlling circuitry which control the operation of the nonvolatile storage 105.

The nonvolatile storage device 109 is a storage device such as a NAND flash memory, MRAM, or FRAM®.

The volatile storage device 108 is a hardware storage device such as a DRAM or SRAM.

Assume that the volatile storage device 108 is a device which can store a smaller amount of information than that of the nonvolatile storage device 109 and has excellent random accessibility. Also assume that the nonvolatile storage device 109 is a device which requires no electric power for holding information but has a limitation (upper limit) in the number of rewrite cycles.

An example in which a DRAM is used as the volatile storage device 108 and a NAND flash is used as the nonvolatile storage device 109 will be described below.

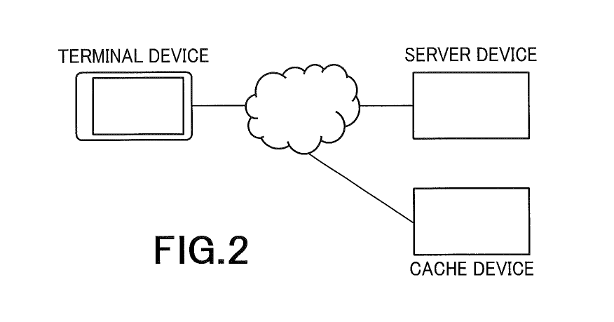

FIG. 2 is a schematic diagram showing a network system including the cache device shown in FIG. 1. A terminal device that sends a request to acquire data and a server device that provides the requested data are connected via a network. The cache device is also connected to the network in a state where the cache device is accessible from the terminal device. FIG. 2 illustrates that the server device and the cache device are connected to the same network. However, in practice, these devices may be connected to different networks. It is desirable that the cache device be connected to a location closer to the terminal device than the server device so that the terminal device can enjoy the effect of cache of data. However, the location where the cache device is connected is not limited to this. The cache device may be provided in a relay device such as an access point.

When the terminal device transmits a request to acquire data, the cache device receives the acquisition request by an appropriate means (for example, the acquisition request may be received by stealing a communication packet, or the communication request may be transmitted to the cache device by using a mechanism such as a DNS). The cache device attempts to read data by generating a read instruction, and when the data requested by the acquisition request is stored in the volatile storage 102 or the nonvolatile storage 105 and is valid, the cache device transmits a response using the data. If the data is stored in neither the volatile storage 102 nor the nonvolatile storage 105, the cache device acquires the data from the server device, generates an instruction to write the data, stores the data in the volatile storage 102 or the nonvolatile storage 105, and transmits the data to the terminal device. The data stored in the cache device is, for example, data which has previously been requested by the terminal device or another terminal device. However, the cache device may voluntarily acquire data which has never been requested by the server device and store the data.

In practice, the data acquisition request transmitted from the terminal device, the data transmitted from the cache device, and the like are transmitted by packets according to a communication protocol to be used. Specifically, the information is set to a payload part and the payload part to which a header and the like are added is used as a packet, and then the packet is transmitted. The transmission unit is called in various ways depending on the communication protocol to be used. The transmission unit may be called a frame, instead of a packet. The name of the transmission unit is not limited to these names.

An expiration date is given to the data, which is provided by the server device, by any means. For example, an expiration date is set by an Expires header or the like in an HTTP header. The cache device sends a response to the terminal device while determining the validity of temporarily stored data (whether data has expired or not) by using the expiration date. The validity of the stored data may be confirmed at a timing of reading the data when responding to the terminal device, or a process of confirming the expiration date of the stored data may be periodically executed. The next expiration date and the data corresponding to the next expiration date may be stored in a linked manner, and a process of collectively deactivating the associated data may be performed when the arrival of the expiration date is confirmed.

In the storage device of the related art, the process of actively deleting data which has been determined to be invalid when the expiration date of the data has expired is not carried out. This is because if the process of actively deleting the data is repeated, an unused area is generated intermittently in the storage device, regardless of the order in which data is written, which may result in deterioration of the usage efficiency of the storage device. Further, if the deletion process can be executed only in units of blocks, like in a NAND flash, when other valid data included in the same block are left, the valid data need to be saved in another block. As a result, the operation efficiency deteriorates and the number of rewrite cycles of each storage element (or each unit) retaining the data increase.

Thus, one feature of the first embodiment is to prevent the above-mentioned problems by effectively controlling data write into the nonvolatile storage device 109 based on the expiration date.

The storage I/F 106 of the nonvolatile storage 105 receives an instruction to write data having the expiration date from the controller 101, and sends the instruction to the storage controller 107. When the controller 101 receives the data having the expiration date acquired from the server device, a write request is generated in the controller 101, and the controller 101 generates a write instruction in response to the write request. This write instruction includes a set of (an identifier, an expiration date, and data). As described above, information about the expiration date is generated by the process of the controller 101 from meta-information (in the above example, an Expires header in an HTTP header) which is associated with the information received via the network.

There are various methods for expressing a time limit in the meta-information received via the network. Examples of the method include a method of directly designating specific date and time, and a method of designating an elapsed time from the present time. Assume herein that a time limit is expressed by the method of directly designating the date and time. However, the both conversion operations are not difficult, and thus can be implemented by any method. The expiration information according to the present embodiment may include any of these cases.

The write instruction may include other types of information, such as a data length, in addition to the set of (an identifier, an expiration date, and data). In this case, however, an example in which the write instruction does not include other types of information will be described.

Further, “data” in the set of (an identifier, an expiration date, and data) may be data itself or an address of a memory (such as the volatile storage 102 or an SRAM incorporated in each element (block) in the block diagram) which stores data.

The storage controller 107 which has received the write instruction stores the data designated by the write instruction in the volatile storage device 108. The storage area of the volatile storage device 108 is also referred to as a temporal write area.

Further, the storage controller 107 creates a management entry (an identifier, an expiration date, and an address where data is stored) based on the write instruction, and registers the management entry to the volatile storage device 108. The registered management entry is also referred to as cache data management information (or simply as data management information). The size of data can be calculated from the address where data is stored. However, the size of data may be added to the cache data management information.

Here, “identifier” in the management entry (cache data management information) may be the same as the identifier included in the write instruction, or another identifier may be newly allocated and this identifier may be used as the identifier of the cache data management information. In this case, “identifier” may be a name by which data can be directly specified, or may be a bit string of a fixed length which is derived from the name or the like. Further, the identifier may be a bit string (such as an i-node No.) for specifying a location on a file system managed by the controller 101 of the cache device, or may be a unique bit string (such as a combination of a head No., a track No., and a sector No.) representing a location on the nonvolatile storage 105. A method for retaining the cache data management information and the data in the volatile storage device 108 will be described later.

As described later, the volatile storage device 108 also stores management information about the nonvolatile storage device 109 (hereinafter referred to as device management information). The storage controller 107 performs the registration and update of the device management information. The device management information retains the number of rewrite cycles corresponding to a unit area, which is a write unit of the nonvolatile storage device 109 and a flag or the like indicating the validity of one or more pieces of data stored in the unit area. For example, when data is written into the nonvolatile storage device 109 in units of blocks, the device management information retains the number of rewrite cycles corresponding to each block (unit area) and the flag indicating the validity of one or more pieces of data stored in each block. Details thereof will be described later.

In the first embodiment, the nonvolatile storage 105 includes the volatile storage device 108. However, if the nonvolatile storage 105 includes a buffer for storing one or both of the cache data management information and the data designated by the write instruction received from the controller 101, the volatile storage device 108 need not be provided. For example, the volatile storage device 108 may be eliminated from the nonvolatile storage 105 and only the nonvolatile storage device 109 may be used. In this case, a device (such as an SLC NAND flash or an MRAM) having a property different from that of the large-capacity nonvolatile storage device 109 which stores data may be used in combination for the cache data management information. Further, the volatile storage device 108 may have a relatively small size for storing only the cache data management information, and a method using various types of nonvolatile storage devices 109 may be used, for example, to store actual data.

When a predetermined condition is satisfied, the storage controller 107 selects data in the temporal write area on the volatile storage device 108 by using the proximity of the expiration date (selects data with the same or close expiration dates), and moves the data to the area of the nonvolatile storage device 109 in a size unit which enables an efficient access to the nonvolatile storage device 109 (i.e., a unit of a unit area having a predetermined size).

For example, one piece of data may be selected by any method, and data may be additionally selected in an order of closer date with respect to the expiration date of the data so that the total size of data becomes equal to an integral multiple of the size unit. Padding data may be added to adjust the total size of data. If there are a large number of pieces of data with the same expiration date, the data with the expiration date may be preferentially selected from the pieces of the data. The amount of data to be moved to the nonvolatile storage device 109 may be determined by any method.

When the data in the volatile storage device 108 is classified into a plurality of groups to be managed, data may be preferentially selected from the same group. Further, when the data in the volatile storage device 108 is stored in an area for each group, it can be determined whether the predetermined condition is satisfied or not for each group. The group will be described later.

Examples of the predetermined condition include the following conditions.

(First condition) The usage rate of the volatile storage device 108 has reached a predetermined rate (including a case where, even if the predetermined rate is not reached, new information or data cannot be added). When the area of the volatile storage device 108 is divided according to the group, this determination may be made for each group.

(Second condition) When the total size of the data stored in the volatile storage device 108 is equal to or more than an integral multiple of a size capable of efficiently performing a process of writing data into the nonvolatile storage device 109. This condition may include a case where the total size of the data is in a range from a value which is smaller by an offset value than the value of the integral multiple of the size capable of efficiently performing a write process to the value of the integral multiple. The offset value is, for example, a value smaller than the size capable of efficiently performing the write process.

(Third condition) When a predetermined time has passed after data is stored in the volatile storage device 108 (only the data when the predetermined time has passed may be moved, or other data as well as the data when the predetermined time has passed may be moved so that the total size of the data becomes close to or matches the integral multiple of the size capable of efficiently performing the write process).

When any one of the predetermined conditions is satisfied, the device management information (to be described in detail later) of the nonvolatile storage device 109 that is stored in the volatile storage device 108 is referred to and the area in which data can be stored in the nonvolatile storage device 109 is specified. Assume herein that the device management information is stored in the volatile storage device 108. However, the device management information may also be stored in the nonvolatile storage device 109. Further, a mechanism for allowing the device management information to be appropriately synchronous between the volatile storage device 108 and the nonvolatile storage device 109 may be provided. In any case, the information about the nonvolatile storage device 109 may be implemented at any location.

When the area of the nonvolatile storage device 109 into which data is stored is determined, a process of moving (writing) the data from the volatile storage device 108 to the area is carried out. When the data is stored in the nonvolatile storage device 109, the data in the volatile storage device 108 is deleted and the cache data management information is appropriately updated so that the information indicates the storage location on the nonvolatile storage device 109 as a storage destination of the data. If the data in the volatile storage device 108 cannot be referred from the information as a result of updating the cache data management information, the data in the volatile storage device 108 may not be deleted (the area for the data is determined to be an empty area, and the area is thereafter overwritten with another data).

### (Operation Flow of Read Process)

A read process of the nonvolatile storage 105 is started when the controller 101 generates a read instruction and the storage controller 107 receives the read instruction via the storage I/F 106. The read instruction includes the identifier of the data to be read and the information of the buffer from which data is read. Assume that this buffer is secured in the volatile storage 102 of the cache device.

The storage controller 107 refers to the cache data management information of the volatile storage device 108, and checks whether the data to be read is stored in the volatile storage device 108. For example, when the identifier is present and the expiration date of the data has not expired, it can be determined that the data is present. When the expiration date of the data has expired, it may be determined that the data is not present. When the data to be read is stored in the volatile storage device 108, the data is read from the volatile storage device 108 and transferred to the buffer, which is secured in the volatile storage 102, via the storage I/F 106. Also, when the data is stored not in the volatile storage device 108, but in the nonvolatile storage device 109, a process similar to the process described above is performed to transfer the data to the buffer secured in the volatile storage 102.

### (Explanation of Cache Data Management Information)

As described above, the storage location and the like of the data stored in the nonvolatile storage 105 (the volatile storage device 108 or the nonvolatile storage device 109) are managed by the cache data management information. There are various methods for implementing the management of the cache data management information. These methods will now be described.

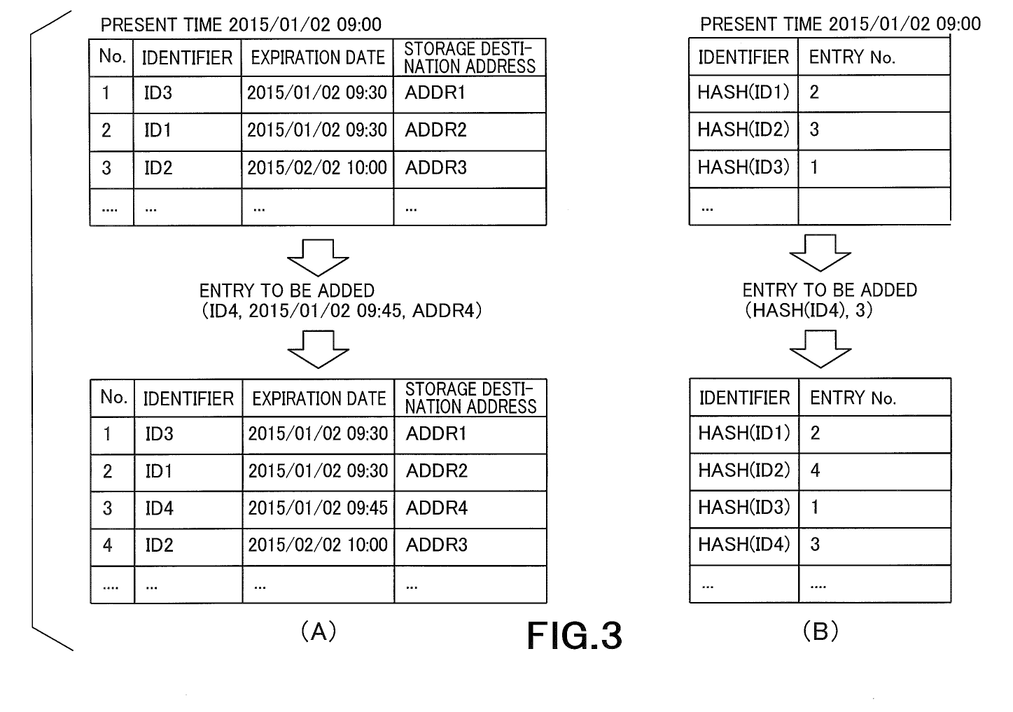

FIG. 3A shows an example of a first method for implementing the management of the cache data management information. This method is a method for managing the cache data management information as one table in which the expiration dates are sorted in an ascending order or a descending order. In this case, when a data write instruction is generated, the expiration date of the data is confirmed and an entry is added to an appropriate location in the table. In order to rapidly read/write data using an identifier, a mechanism (such as a hash table) for associating an identifier with the entry No. of a table may be provided. FIG. 3B shows an example in which the hash value of the identifier and the entry No. of the table are managed in a linked manner. HASH (ID1) represents a hash value of ID1. The rows of the table are sorted in an ascending order or a descending order of the hash value.

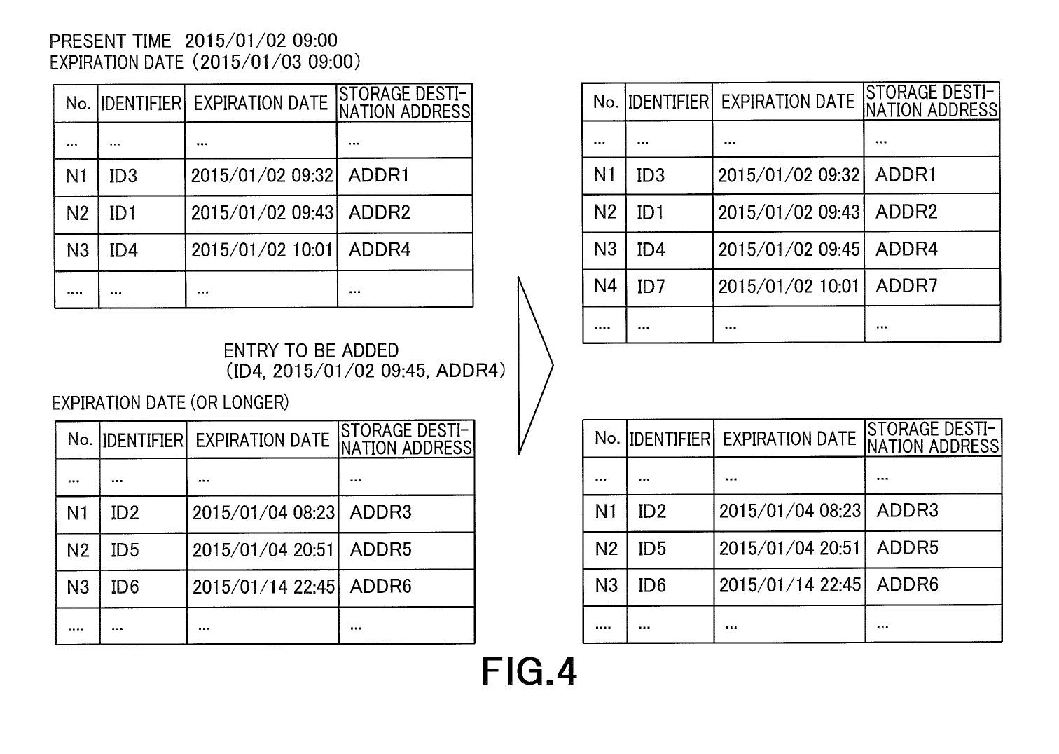

FIG. 4 shows an example of a second method for implementing the management of the cache data management information. This method is a method for classifying the expiration dates by at least one threshold and managing the table for each group. For each table (i.e., for each group), the expiration date of the table (group) is associated aside from the expiration date of the data. The expiration date of the data is compared with the threshold, thereby making it possible to determine which group (table) the data belongs to. When the data write instruction is generated, the expiration date of the data is compared with the threshold to thereby specify the group to which the data belongs, and an entry is added to the table corresponding to the group. A clock for managing the time may be provided in the cache device, or information about the time may be sequentially acquired via the network or an external interface or the like.

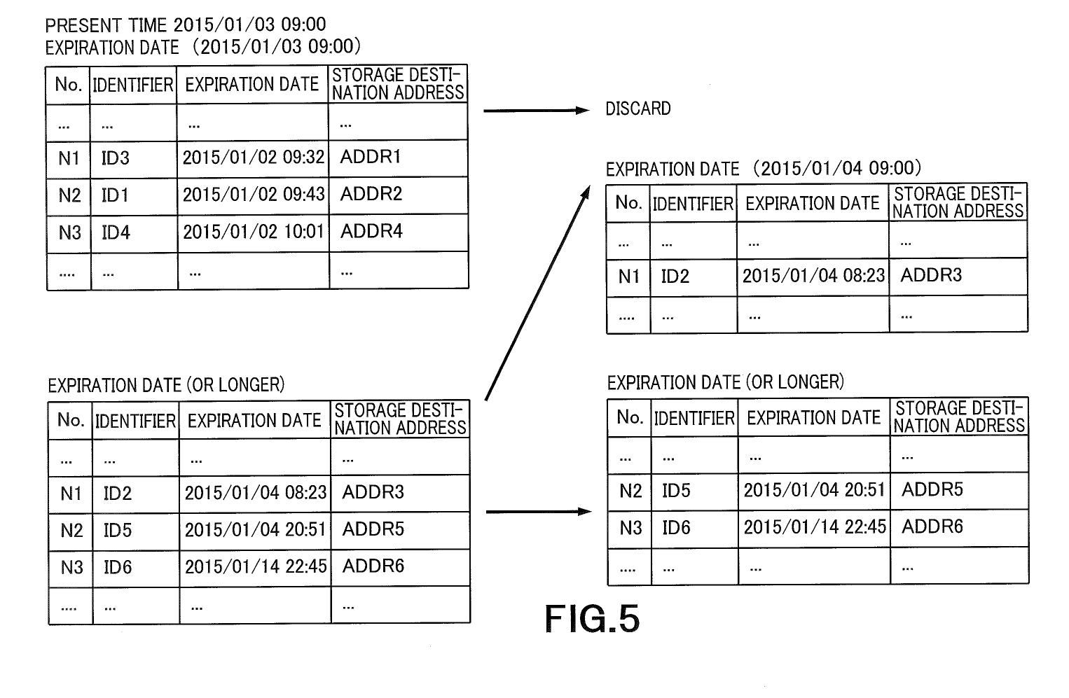

The expired tables are sequentially deleted together with the information managed in the table, and a table having a new expiration date is generated from the remaining tables. FIG. 5 shows an example in which the tables whose expiration date (2015/01/03 09:00) has expired are deleted and the tables having expiration dates after 2015/01/03 09:00 are divided into a plurality of groups. At this time, if the tables are formed in an ascending order of the expiration date, a plurality of new tables can be generated by a simple table division operation. The tables generated by division are desirably formed in such a manner that the tables are associated with the device management information of the nonvolatile storage device 109, as described later. A process of deleting the data indicated by entries (expired entries are assumed) which are registered to the deleted tables can be performed as needed.

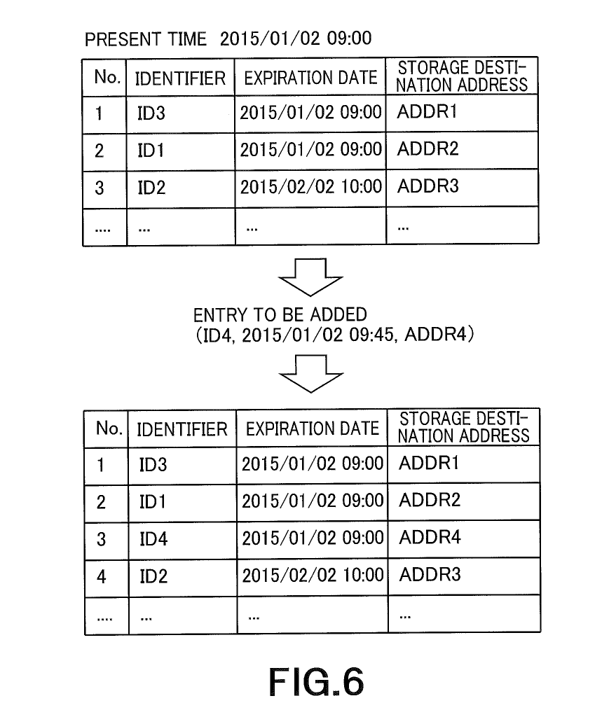

Further, the expiration date can be normalized to a predetermined time unit. FIG. 6 shows an example of a method (third method) when a normalized expiration date is applied to the first method (see FIG. 3). The normalization is performed in units of one hour on the example shown in FIG. 3. In the case of the normalization, an excess time (45 minutes in this case) is rounded off in order to avoid a response after the expiration date. As a result, while “2015/01/02 09:45” is designated as the expiration date of the entry, but the time is rounded to “2015/01/02 09:00” and added. The process of normalizing the expiration date is performed by the storage controller 107 and the controller 101 which has carried out the write instruction is not involved in the normalization process.

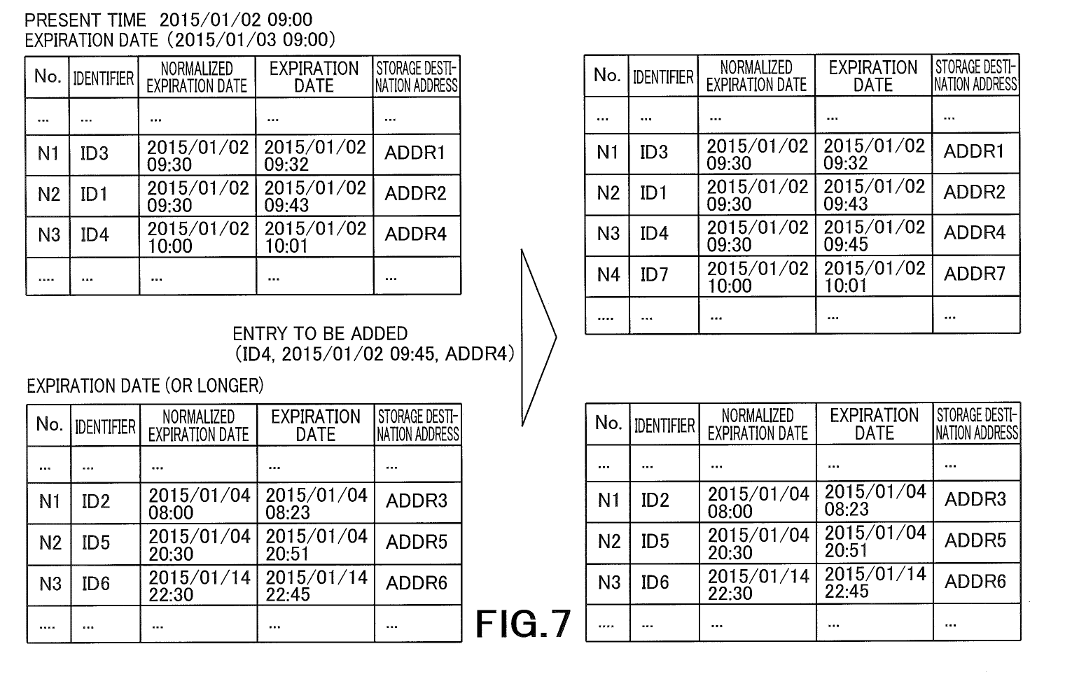

FIG. 7 shows an example of a method (fourth method) when the normalized expiration date is applied to the second method (see FIG. 4). The normalization in units of 30 minutes is performed on the example shown in FIG. 4. While “2015/01/02 09:45” is designated as the expiration date of the entry, the expiration date is rounded to the “2015/01/02 09:30” by normalization and is added to the table on the upper side of the expiration date (2015/01/03 09:00).

In the example shown in FIG. 7, the entries respectively including the expiration dates which are not normalized are strictly managed. In the example shown in FIG. 6, only the normalized expiration dates are used to manage the respective entries, without holding the expiration dates which are not normalized. The expiration dates which are not normalized may or may not be managed. In this case, the normalization granularity and the time unit therefor may be selected according to the characteristics and configuration of the nonvolatile storage device 109 to be used. For example, when the nonvolatile storage device 109 is divided into three areas, an expiration date is normalized to any one of three values (expiration dates).

### (Data Storage Method in Volatile Storage Device 108)

Data instructed to be written into the nonvolatile storage 105 is first temporarily stored (temporal storage is also referred to as “cache”) in the volatile storage device 108. Like the methods (see FIGS. 3 to 7) for managing the cache data management information, there are a plurality of implementation methods as the data storage method in the volatile storage device 108.

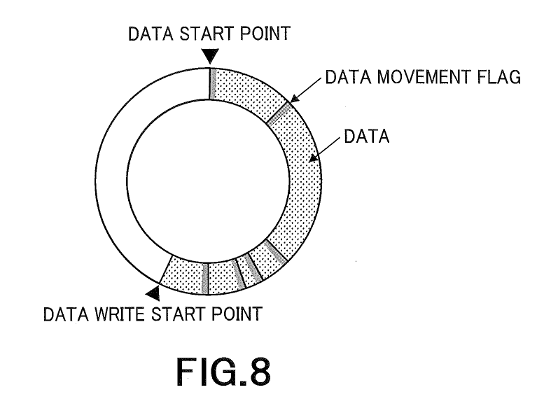

A first data storage method is a method of storing data without any special structure. For example, a ring buffer may be formed on the volatile storage device 108 so as to implement the storage and read of data. In this case, since the data is moved to the nonvolatile storage device 109 according to the expiration date, the data stored in the volatile storage device 108 are not necessarily moved to the nonvolatile storage device 109 in the order from the forefront. Accordingly, a mechanism (data movement flag) for managing whether or not to move the data on the ring buffer is provided. FIG. 8 shows an example in which the ring buffer stores data. In this example, six pieces of data are stored in the buffer of the volatile storage device 108. The data movement flag is retained at the head of each piece of data. When the data is moved to the nonvolatile storage device 109, the data movement flag retained at the head of the data is changed to show that the data has been moved.

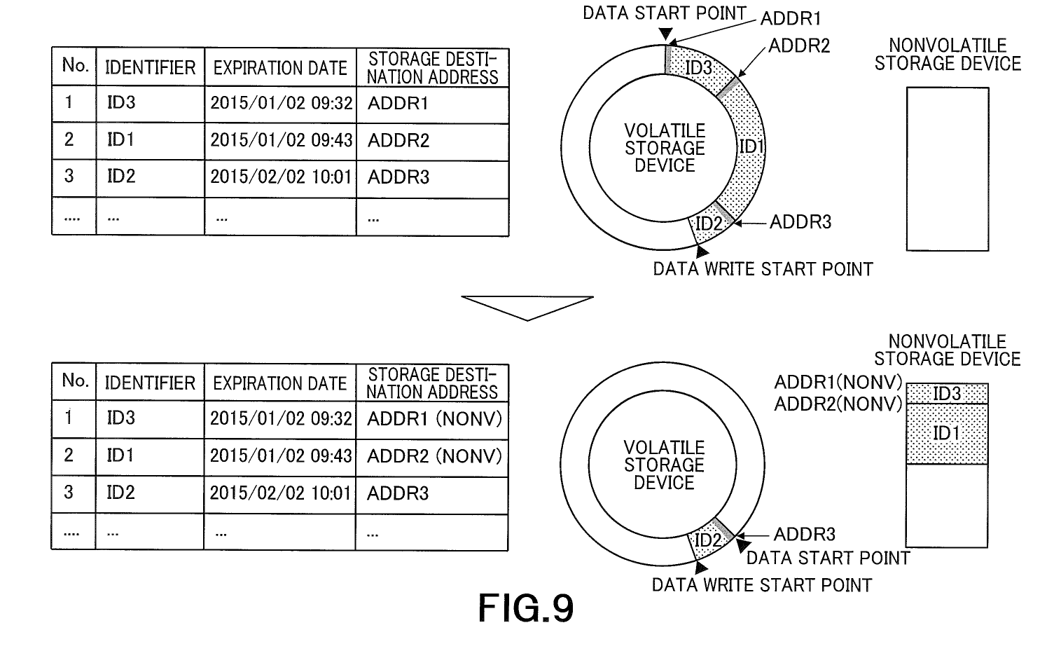

As another example using the ring buffer, a state shown in the upper part of FIG. 9 is assumed as an initial state. Assume that, among the three conditions for moving data from the volatile storage device 108 to the nonvolatile storage device 109 as described above, the condition (the above-mentioned third condition) that data when a certain time has passed is moved is satisfied. In this case, the condition is satisfied for the entries of No. 1 and No. 2 (ID1 and ID3), and is not satisfied for the entry of No. 3 (ID2). The storage controller 107 integrates the data of ID1 and the data of ID3, and performs, as needed, a process of performing padding so that the data has a size that can be efficiently written into the nonvolatile storage device 109, and writing the data into the nonvolatile storage device 109. Assume that the pieces of written data can be specified by ADDR1 (NONV) and ADDR2 (NONV), respectively. As a result of executing a series of processes, the cache data management information is updated as shown in the lower part of FIG. 9, and the pieces of data indicated by the entries (ID1 and ID3) are stored in the nonvolatile storage device 109, while the data indicated by the entry ID2 remains in the volatile storage device 108. In this example, the data movement flag is not used. If the data when a certain time has passed is moved, the data may be moved in such a manner that the data having_the same or close expiration dates are moved to belong to the same block or close blocks at the destination.

When the data is moved from the volatile storage device 108, if the data is discretely moved, a flag is set to an empty area which is sandwiched between the areas being used in the volatile storage device 108 as the result of the moving. Thus, the area sandwiched between the areas being used indicates an unused area. In this case, a data start point in the ring buffer is appropriately set in consideration of the status of the buffers used in a discrete manner.

A second data storage method is a method of dividing an area for data storage in the volatile storage device 108 based on an expiration date. In this case, it is preferable to divide the area based on the threshold or normalization granularity used in the second to fourth methods described in the above explanation of the cache data management information.

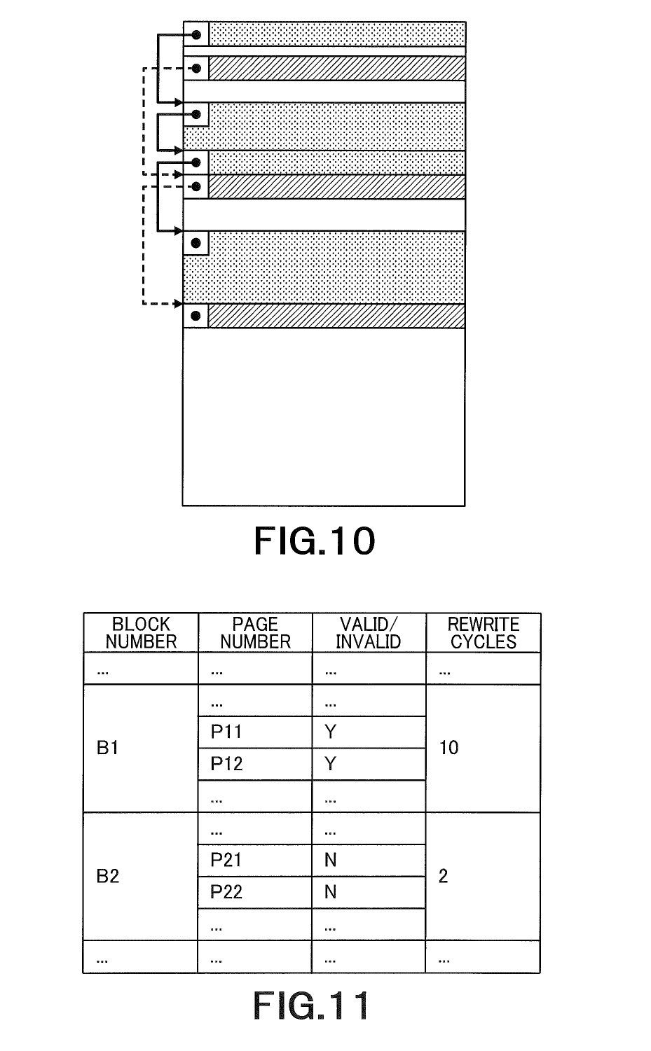

FIG. 10 shows an example in which the temporal write area (area for data storage) in the volatile storage device 108 is divided into two areas to be managed. Assume that the cache data management information is also divided into two pieces as shown in FIG. 7. In the example shown in FIG. 10, the two areas divided by the threshold of the expiration date are formed of different link lists, respectively, thereby implementing the division. The plurality of divided areas (buffers) may be implemented using two ring buffer formats as shown in FIG. 8. Further, the buffers may be secured by changing an offset, to thereby implement the plurality of divided areas (buffers). Furthermore, a plurality of volatile storage devices 108 may be provided and function as different buffers.

Regardless of which one of the first data storage method and the second data storage method is used, it is preferable that the amount of data that can be stored in the volatile storage device 108 be an integral multiple of a unit (a block unit if a NAND flash is used) with which data can be efficiently written in the nonvolatile storage device 109.

### (Explanation of Device Management Information)

The storage controller 107 included in the nonvolatile storage 105 manages the state of the nonvolatile storage device 109. The storage controller 107 manages the state of the nonvolatile storage device 109 by using the device management information. For example, when data is written into the nonvolatile storage device 109 in units of blocks, the device management information retains a flag indicating the number of rewrite cycles corresponding to each block and the validity of information stored. The flag indicating the validity is activated when the data is written. When the expiration date has expired, or when a Trim command is received from the controller 101, the flag is deactivated. Another information may be additionally retained as the device management information. However, another information is not relevant to the essence of the first embodiment, and thus the description thereof is omitted.

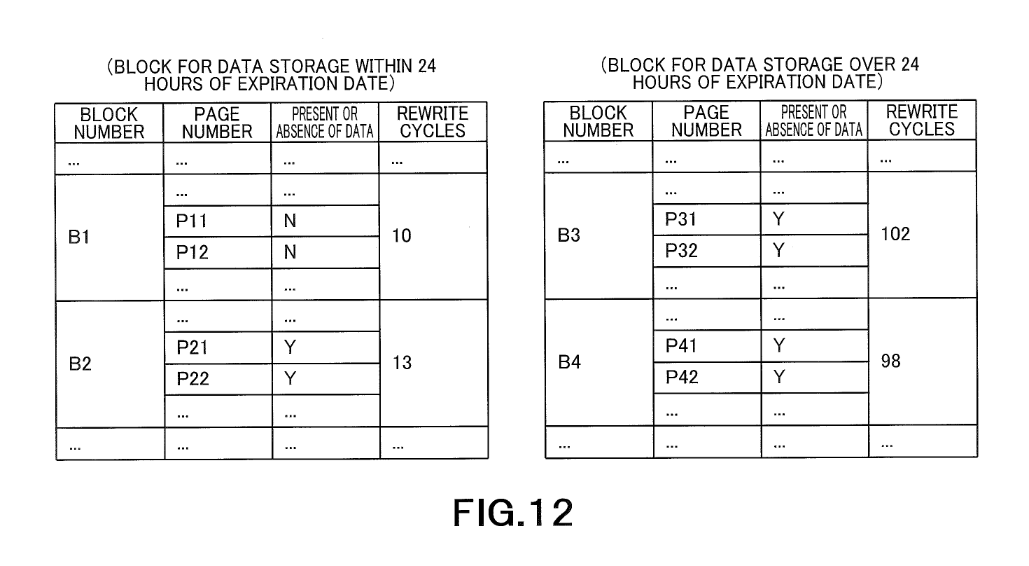

The device management information is stored in, for example, the volatile storage device 108. In this case, the entire device management information may be managed (managed in one area) in the manner as described in the explanation of the cache data management information, or the device management information may be divided into a plurality of pieces according to the expiration date and managed (a plurality of divided pieces of information may be managed in respective areas). For example, the device management information may be divided into information for managing data with expiration date before a first time point and information for managing data after a second time point. FIG. 11 shows an example in which the device management information is managed in one area. FIG. 12 shows an example in which the device management information is managed by a plurality of areas. Each block in the nonvolatile storage device 109 is formed of a plurality of pages of a predetermined size, and data can be deleted and written in units of blocks. Each page is identified by a page No. (see FIGS. 11 and 12). When a page is added to a block, it is necessary to write the saved page and the added page into the block after the written page of the block is temporarily saved and the entire information included in the block is deleted.

In FIG. 11 or FIG. 12, the entries each managed by the device management information may be arranged, for example, in the order of unit storage area (in the order of block No.), may be arranged in an ascending order (or a descending order) of the number of rewrite cycles, or may be arranged in any order. A writable area (an area in which no valid data is stored) and a non-writable area (an area in which valid data is stored) may be managed separately, or may be managed together.

(Specification of Storage Destination with Reference to Device Management Information)

When the storage controller 107 determines the data storage location in the nonvolatile storage device 109, the number of rewrite cycles of each block included in the device management information and the data size and expiration date included in the write instruction are referred to. Specifically, when the storage controller 107 receives the write instruction, the storage controller 107 determines the data storage location (block) using three values of (data size, expiration date, and the number of rewrite cycles of a candidate block) as parameters.

For example, a function for outputting an evaluation value (or adequacy value) of each write candidate block is calculated from the three parameters of (data size, expiration date, and the number of rewrite cycles of a candidate block), and the block is determined based on an appropriate value. In this case, the data size is used to determine whether the target block (this block may be a plurality of blocks) has a size capable of storing data instructed to be written. Two remaining parameters (expiration date and the number of rewrite cycles) determine the evaluation value of the write candidate block. The number of rewrite cycles need not be used, and a configuration for determining the block into which data is written can be employed without considering the number of rewrite cycles.

An example of the method is a method of dividing the area of the nonvolatile storage device 109 in accordance with the division of the cache data management information. Specifically, the location where data is stored in the nonvolatile storage device 109 is specified depending on whether the expiration date is larger or smaller than the threshold (to which group (expiration date range) divided by the threshold the data belongs). In this case, the number of rewrite cycles of each block of the nonvolatile storage device 109 need not be considered. There is need to perform a process (wear leveling) of smoothing the number of rewrite cycles for each block, independently of the process of determining the data write location. An average value of the number of rewrite cycles of a plurality of storage elements included in the block can be used as the number of rewrite cycles for each block. The wear leveling may be performed for each of the divided areas, or may be performed over a plurality of the area. When the wear leveling is performed over a plurality of areas, the correspondence relation between the above-mentioned expiration date range and the area is changed by the wear leveling.

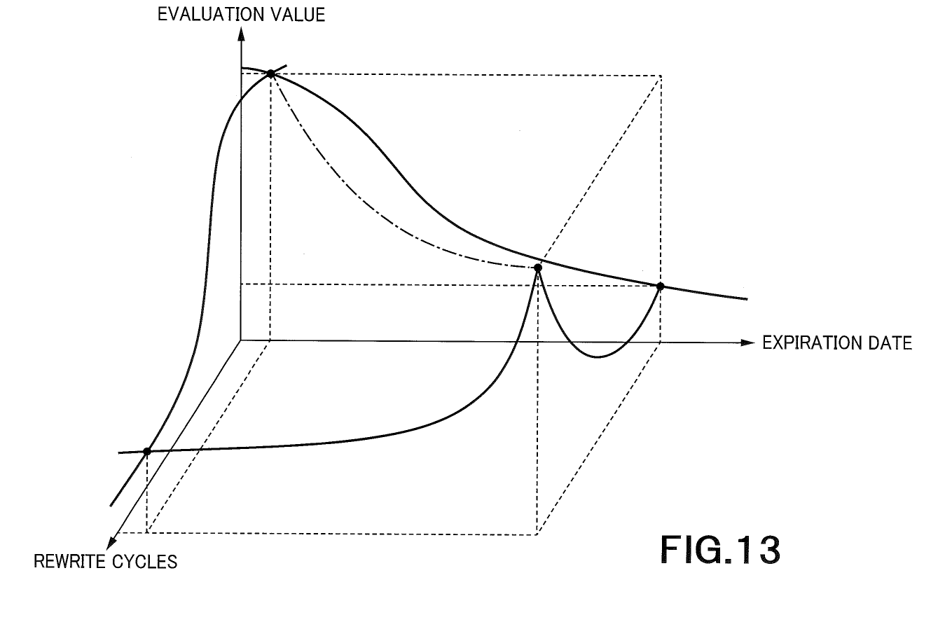

Further, a concept of an evaluation value for each block or for each block group including a plurality of blocks can be introduced to more flexibly determine the write location. In a case where a candidate of a block to be written is specified by the expiration date designated by the write instruction and the rewrite process is repeated in the selected block, when a block in which a rewrite interval is shorter than a predetermined threshold (for example, a rewrite interval assumed at the time of design of the nonvolatile storage device 109) is generated, blocks with less the number of rewrite cycles desirably have a higher evaluation value than that of the blocks with more the number of rewrite cycles. On the contrary, in the case of a block with a longer rewrite interval than the threshold, it cannot be said that it is inappropriate to set the blocks with more the number of rewrite cycles as write target blocks. In consideration of the lifetime of the entire device, the evaluation value of the blocks with more rewrite times can be set to be higher than that of the blocks with less rewrite times, based on the relationship between the expiration date and the evaluation value. The evaluation value for each block (or each block group) is calculated according to the criteria described above, so that the rewrite frequency can be reduced as a whole, the effect of delaying the deterioration of the data storage area can be expected, and the effect of increasing the entire operating time of the nonvolatile storage device 109 can also be expected. FIG. 13 shows an image of the function. FIG. 13 illustrates a continuous function. However, in practice, a function for outputting a discrete value may be used.

The evaluation value may be calculated every time the data write instruction is received, or may be calculated at constant intervals and registered to the device management information. When the expiration date is normalized, the evaluation value is calculated in advance to conform to each normalization unit, and the device management information may be configured in such a manner that the values are arranged in a descending order or an ascending order.

### (Deletion of Expired Data)

It is necessary to delete, as invalid data, expired data from the nonvolatile storage 105 at an appropriate timing. Specifically, there are two methods, i.e., a method (first method) of securing an empty area by actively detecting and deleting invalid data, and a method (second method) of rewriting the invalid data with new data when the new data is added.

The first method will be described first. As described above, the volatile storage device 108 retains the cache data management information. The storage controller 107 executes a process (deactivation process) for periodically deleting the expired data based on the information. Since the data having the same or close expiration dates are integrated in each block (unit area) as a deletion unit, the deactivation process is carried out at an appropriate timing, which makes it possible to delete the data collectively. Accordingly, even when a NAND flash is used as the nonvolatile storage device 109, the need for a process of saving and writing back data is eliminated. This makes it possible to actively secure the empty area and improve the responsiveness. Further, the need for garbage collection for collecting unused areas in a block is eliminated. When the expiration dates are, for example, normalized to divide the data into a plurality of groups to be managed as described above, the process of securing the empty area may be executed for each group. When the deactivation process is completed, the device management information is updated appropriately so that the block in which the deactivation process is completed can be used thereafter. When there is the expired data before the data is moved to the nonvolatile storage device 109 among the data stored in the temporal write area of the volatile storage device 108, the data may be deleted from the volatile storage device 108.

On the other hand, in the second method, the cache data management information is referred to when new data is written, and the expired block is specified. After that, the deactivation process (delete process) is executed on the specified block, and new data is written. In this case, the number of rewrite cycles are incremented for the block in which the device management information is written. In the second method, the expired block is specified when a rewrite occurs, and it takes more time to perform the write process than in the first method. However, there is an advantage that the need for a background process is eliminated. When the size of new data is larger than the size of the block, the expired blocks are continuously searched until the total size of data becomes equal to or larger than the size of new data, and a plurality of blocks are specified as rewrite target blocks. When a status in which the expiration dates of some pieces of data in the block have expired and the expiration dates of some of the remaining pieces of data have not expired is permitted, expired data may be searched until the total size of the expired data becomes equal to or larger than the size of new data, and a plurality of blocks including the expired data may be specified as rewrite target blocks. The process of saving and writing back data may be performed on the data which has not expired, when new data is written.

### (Modification of Nonvolatile Storage 105)

To deal with a plurality of different expiration dates (groups), the nonvolatile storage device 109 may be implemented using a plurality of storage devices having different characteristics. More specifically, for example, an SLC NAND flash is used for a portion storing data with a short expiration date (high rewrite frequency), and an MLC NAND flash is used for a portion storing data with a long expiration date (low rewrite frequency). When it is difficult to implement storage elements with different characteristics, the storage elements may be controlled so as to obtain a similar effect in a pseudo manner. Also, when the data with a long expiration date is stored in the MLC NAND flash and the expiration date of the data is about to expire (for example, a time limit is reached in a certain time or less), the data may be moved to the SLC NAND flash.

Similarly, the capacity of a spare area in the nonvolatile storage device 109 may be changed. For example, when the area of the nonvolatile storage device 109 is divided into an area for storing data with a short expiration date and data with a long expiration date and these areas are managed and when a spare area is provided in each of the areas, the spare area in the area for storing data with a short expiration date may be set to be larger than the spare area in the area for storing data with a long expiration date. Further, the intensity of an error correction code when data is written into the nonvolatile storage device 109 may be changed. For example, the error correction code in the area for storing data with a long expiration date may be set to be higher than the error correction code in the area for storing data with a short expiration date so that the tolerance for a long hold can be increased. Further, charge thresholds (for example, to deal with multiple levels representing four states of “11”, “10”, “01”, and “00” according to the amount of charge) for detecting a value when data is read may be adjusted. For example, one threshold of the area storing data with a long expiration date may represent two states, and three thresholds of the area storing data with a short expiration date may represent four states. Like these thresholds, various parameters may be adjusted so as to improve the storage capacity or the operation speed, while the data is retained accurately according to the expiration date.

It is necessary for the storage device using a NAND flash to have a wear leveling function for smoothing the number of times of write in each block (for example, an average of the number of times of write of storage elements included in each block). In the first embodiment, when the area of the nonvolatile storage device 109 is divided into a plurality of areas based on the expiration date, wear leveling may be executed only on the inside of each divided area corresponding to the expiration date range (group), or wear leveling may be executed over a plurality of divided areas. When wear leveling is performed only on the inside of each group, wear leveling is executed on the blocks having the same or close deletion timing, which is advantageous in facilitating smoothing. However, since a bias (unevenness) of the number of times of write occurs between the groups, when the storage devices having the same characteristics are used for these areas, it is desirable to periodically perform a process of leveling the number of times of write between the groups. In this case, the correspondence relation between the expiration date range (group) and the areas is changed by wear leveling.

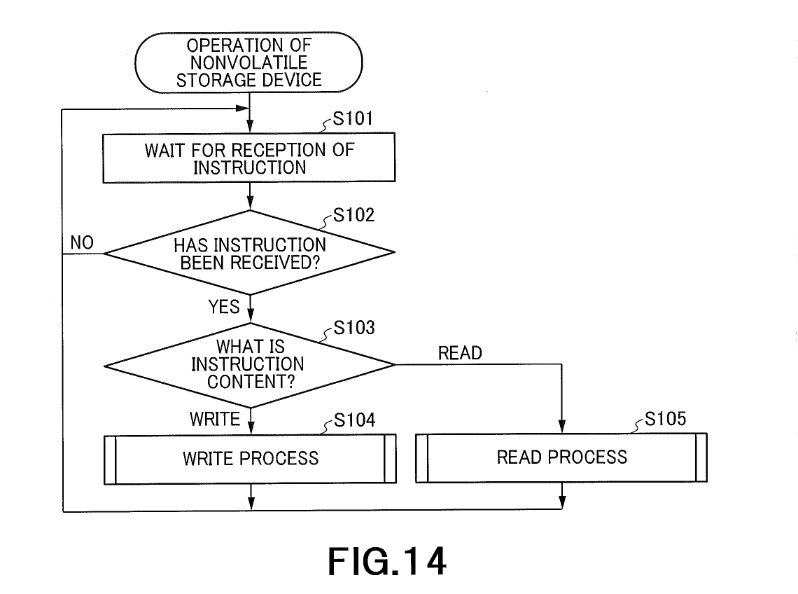

FIG. 14 shows a flowchart of the overall operation of the nonvolatile storage 105 according to the first embodiment. When the storage controller 107 receives an instruction from the controller 101 via the storage I/F 106 (YES in S101 and S102), it is determined whether the instruction is a write instruction or a read instruction (S103). When the instruction is a write instruction, the process proceeds to the write process (S104), and when the instruction is a read instruction, the process proceeds to the read process (S105).

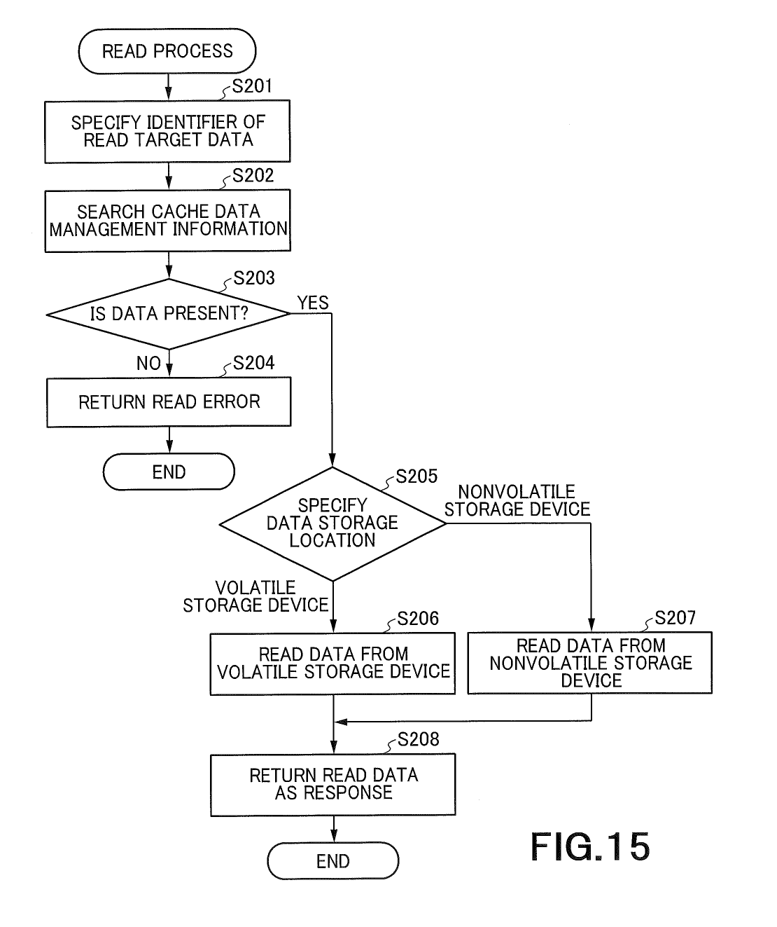

FIG. 15 shows an example of an operation flow when the read instruction is received in step S105 of FIG. 14. The identifier of the data designated by the read instruction is specified (S201). After that, the cache data management information stored in the volatile storage device 108 (S202) is searched and the storage destination of the identifier is specified (S203). When the cache data management information indicates that, there is no data to be read, a response indicating a read error is sent back (S204). When the cache data management information indicates that there is data to be read, it is determined whether the data is stored in the volatile storage device 108 or the nonvolatile storage device 109 (S205). This determination is made using, for example, an address included in the cache data management information. Alternatively, the cache data management information may retain information for specifying the storage device (the volatile storage device 108 or the nonvolatile storage device 109). When the storage device is specified by any method, the storage device is accessed to read data by using the address included in the entry of the cache data management information (S206, S207). A response including the data acquired from the storage device is sent back to the controller 101 via the storage I/F 106 (S208).

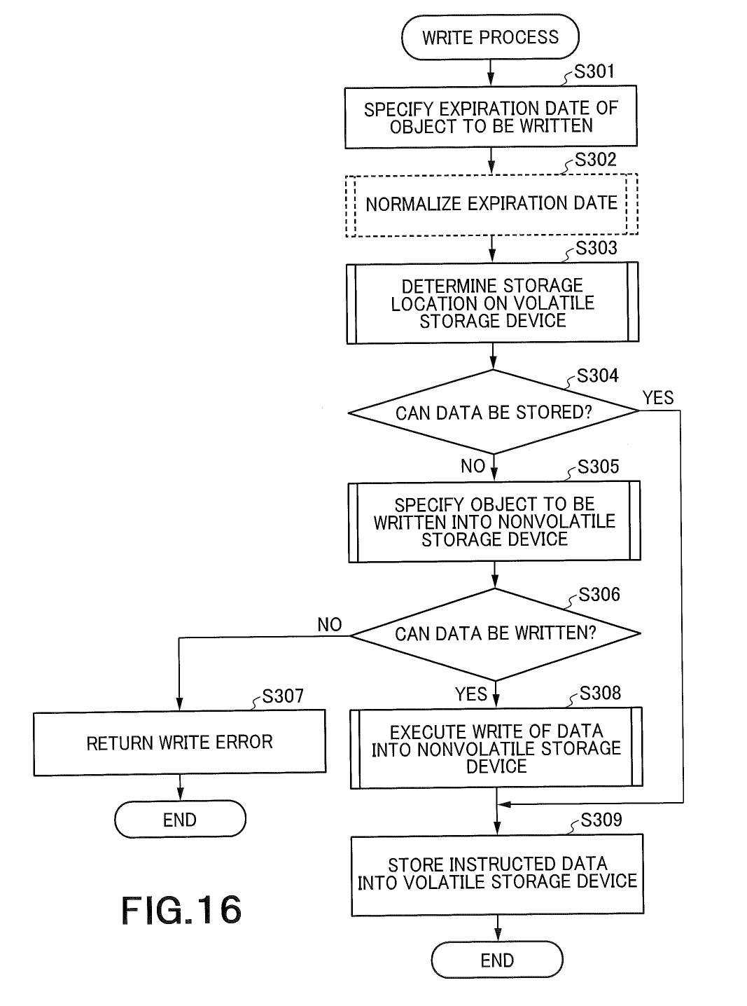

FIG. 16 shows an example of an operation flow when the write instruction is received in step S104 of FIG. 14. As described above, there are a plurality of processes for moving data from the volatile storage device 108 to the nonvolatile storage device 109. One example of the processes is described herein, and flowcharts of the other processes are omitted for ease of explanation.

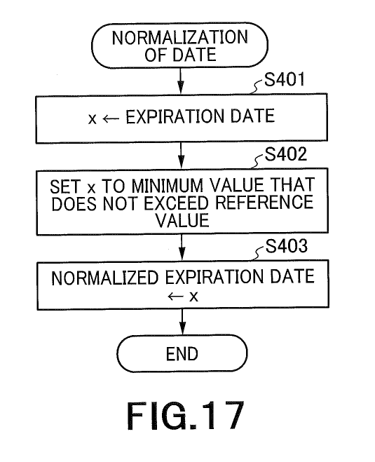

First, the expiration date included in the write instruction is acquired (S301). The acquired expiration date is normalized as needed (S302). As described above, the normalization indicates, for example, a process of rounding the expiration date so as to achieve predetermined time intervals. FIG. 17 shows an example of an operation flow of the normalization process. In a status where a plurality of reference values is set in compliance with a predetermined time unit, a minimum reference value (minimum value) that does not exceed the value of the expiration date included in the write instruction is specified (S401, S402). When the normalization is performed, for example, every 15 minutes, which is the normalized expiration date (S403), 0 minutes, 15 minutes, 30 minutes, and 45 minutes are prepared as reference values. In the case of 20XX/Y/Z 15:32, the closest reference value that does not exceed 32 is 30, so that the normalized expiration date is “20XX/Y/Z 15:30”.

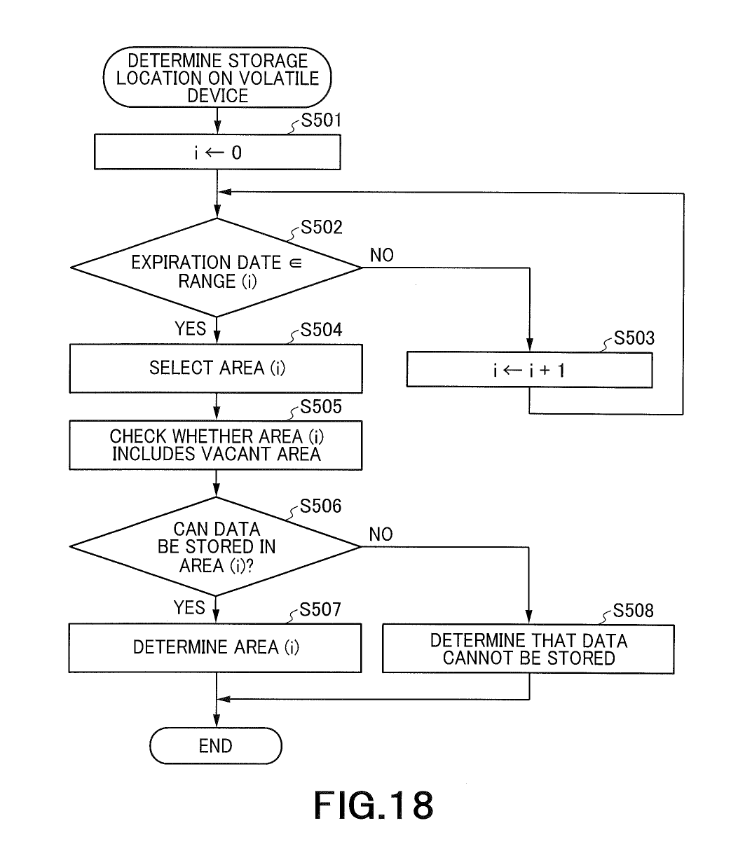

After the above-mentioned normalization is carried out as needed, the storage location when the data instructed to be written is stored in the volatile storage device 108 is determined (S303). FIG. 18 shows an example of the operation flow of this process. Assume that the area of the volatile storage device 108 is divided into one or more areas based on the expiration date (“one or more” implies that the area may not be divided). In other words, the expiration date is set in each area, and the expiration date corresponds to the expiration date in each table when the above-mentioned memory management information is managed by one or more tables. Also assume that the area of the nonvolatile storage device 109 is divided into one or more areas based on the expiration date. For each area in the volatile storage device 108, it is determined whether the expiration date of the data instructed to be written is included in the range (S501, S502, S503, S504). When the area that satisfies the expiration date is specified, it is confirmed if there is an empty area in the specified area (S505). When there is no empty area, it is determined that it is impossible to store data (S508), and when there is an empty area (S507), it is determined that data is stored in the specified area (S507).

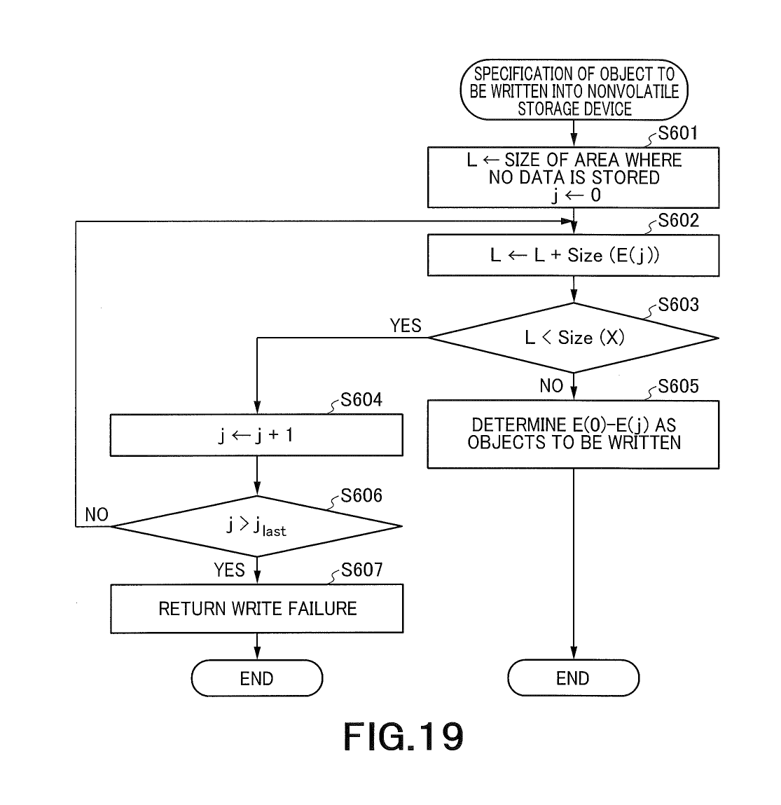

When it is impossible to store data (S508 of FIG. 18, and NO in S304 of FIG. 16), the process of determining the data to be moved to the nonvolatile storage device 109 is performed in the volatile storage device 108 (S305 of FIG. 16). FIG. 19 shows a flowchart showing an example of the operation in step S305 of FIG. 16. Assume herein that the data in the volatile storage device 108 are arranged in an order (descending order) appropriate for storing in the nonvolatile storage device 109.

The data sizes are totalized by sequentially referring to the most suitable data to be written. Then, the area in which these pieces of referenced data are stored is returned as a data write area by continuously referring to the data until the total size becomes equal to or longer than the length of new data to be stored in the volatile storage device 108 (S601, S602, S603, S604, S605, and S606). Even if all pieces of data stored in the volatile storage device 108 are written, when the data cannot be stored (that is, when the size of the volatile storage device 108 is smaller than the size of data to be stored), a write failure is returned (S607). In the flowchart of FIG. 19, “X” represents data to be newly stored in the volatile storage device 108, and E(j) represents a j-th entry of cache data management information corresponding to an area (i) of the volatile storage device 108 (that is, the area (i) stores the data of the j-th entry). Size (E(j)) represents the length of the data corresponding to the j-th entry, and “jlast” represents the last entry among the entries included in the cache data management information.

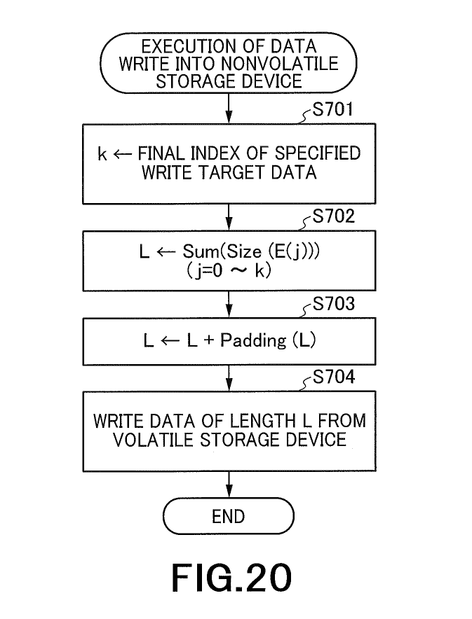

When the data to be moved from the volatile storage device 108 to the nonvolatile storage device 109 is specified, a process of actually writing the specified data into the nonvolatile storage device 109 is carried out (YES in S306 of FIG. 16, S308). FIG. 20 shows an example of an operation flow of the process of writing data into the nonvolatile storage device 109 which is carried out in step S308 of FIG. 16. As described above, this process is executed using the data size, which enables the nonvolatile storage device 109 to efficiently operate, as a unit. Specifically, in the case of a NAND flash, a write is executed using a block as a unit. The specified data are integrated in step S605 of FIG. 19 (S701, S702). If the integrated data do not match the unit of the block (the integral multiple of the block size), padding is executed (S703) and then the data is written into the nonvolatile storage device 109 in units of blocks (S704). In the flowchart of FIG. 20, “Sum (Size (E(j)))” represents the size of the integrated specified data in step S605 of FIG. 19. Padding (L) represents the padding size of the size necessary for the size that enables efficient data write into the nonvolatile storage device 109.

The operation of the nonvolatile storage 105 in the first embodiment has been described above. In the series of explanations, the case where the data stored in the volatile storage device 108 are sequenced in advance based on any criterion has been described above. The data may be sequenced in the order of data write into the ring buffer as shown in FIG. 8; the data may be sequenced in the order of evaluation values calculated for each data; the data may be sequenced in an ascending order (descending order) of expiration dates; or the data may be arranged in the order of identifiers. When evaluation values are used, in order to obtain a status in which evaluation values are aligned in advance when the write instruction is received, a process of calculating the evaluation values for each data when the volatile storage 102 is in an idle state and realigning the evaluation values may be executed. Alternatively, the evaluation value may be calculated when the write instruction is actually received.

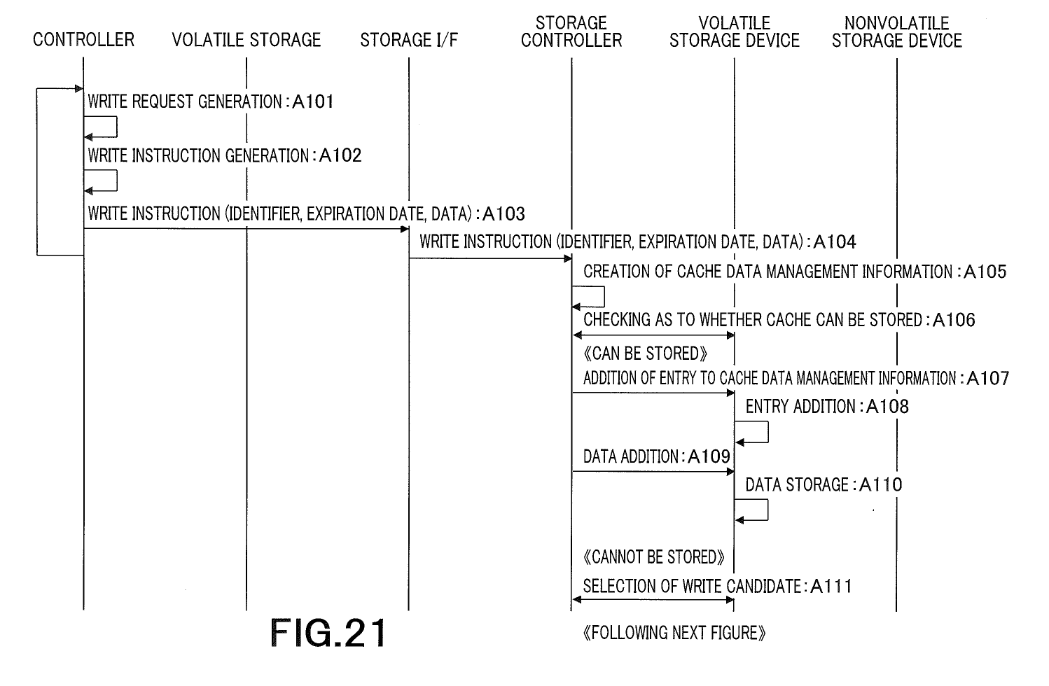

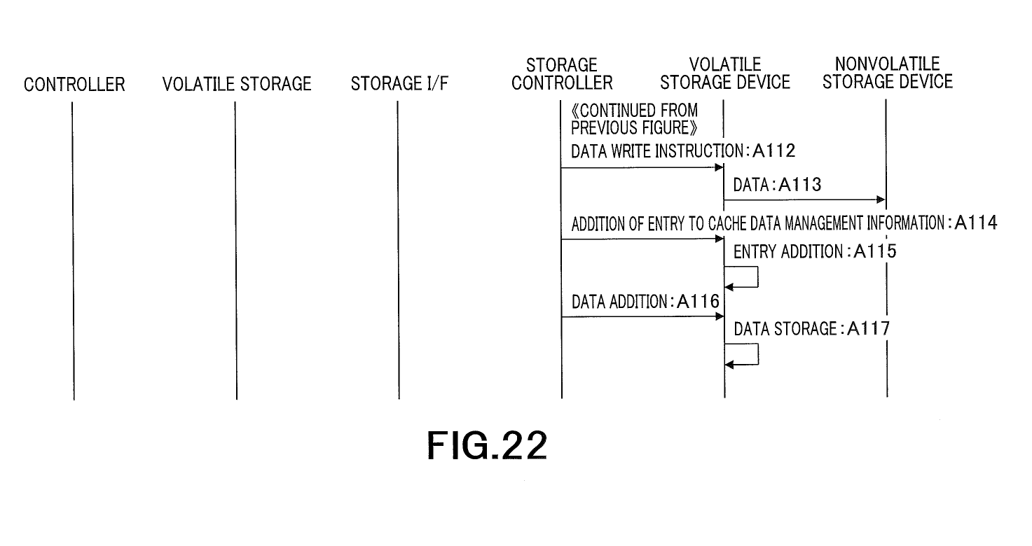

FIG. 21 shows an example of a sequence according to the first embodiment. FIG. 22 shows an example of the sequence following FIG. 21. When the controller 101 receives a write request via the communication I/F 103 (A101), the controller 101 generates a write instruction (an identifier, an expiration date, and data) (A102), and sends the generated write instruction to the storage controller 107 via the storage I/F 106 (A103, A104). The storage controller 107 generates the cache data management information as needed (A105), and determines whether it is possible to store data in the volatile storage device 108 (A106).

If it is possible to store data in the volatile storage device 108, the volatile storage device 108 adds an entry to the cache data management information (A107, A108), and stores the data in the volatile storage device 108 (A109, A110).

If it is impossible to store the data in the volatile storage device 108 (if there is no empty area or no free space), the storage controller selects write candidate data in the volatile storage device 108 (A111), and instructs the volatile storage device 108 to write the selected data (A112 in FIG. 22). The data is read out from the volatile storage device 108 and is written into the nonvolatile storage device 109 (A113). Further, the storage controller 107 adds a new entry to the cache data management information in the volatile storage device 108 (A114, A115), and writes (stores) new data into the volatile storage device 108 (A116, A117).

### (Summary of First Embodiment)

As described above, the first embodiment illustrates a cache device including the controller 101 that sends a data write instruction having an expiration date to the nonvolatile storage 105, and the nonvolatile storage 105 that performs a write operation based on the instruction. The nonvolatile storage 105 collectively performs the data write processes from the volatile storage device 108 to the nonvolatile storage device 109 based on the proximity of the sent expiration date by using the volatile storage device 108 as a temporal write area. In this case, the processes of writing data into the nonvolatile storage device 109 are collectively performed by a unit capable of efficiently writing and updating data. Consequently, even when requests for writing small size of information are frequently made, an increase in the number of rewrite cycles can be suppressed while the write efficiency is maintained.

### Second Embodiment

In the first embodiment, the volatile storage device 108 and the nonvolatile storage device 109 are mounted on the nonvolatile storage 105, and the data stored in the volatile storage device 108 are integrated according to the expiration date and are written into the nonvolatile storage device 109. On the other hand, in a second embodiment, the volatile storage 102 and the nonvolatile storage 105 execute processes similar to those of the first embodiment.

A block diagram of a cache device according to the second embodiment is the same as the block diagram (FIG. 1) of the cache device in the first embodiment. However, the second embodiment differs from the first embodiment in that a part of the control process in the storage controller 107 is executed by the controller 101 of the cache device.

The volatile storage 102 of the second embodiment functions as a write-back disk cache. Specifically, data designated by a write instruction with an expiration date issued by the controller 101 is temporarily stored in the volatile storage 102, and when a predetermined condition is satisfied, an operation of writing the data temporarily stored from the volatile storage 102 to the nonvolatile storage 105 is carried out. Information necessary for the volatile storage 102 to function as a disk cache is substantially the same as that of the first embodiment. That is, the information includes cache data management information and actual data instructed to be written. Elements constituting each entry of the cache data management information may be the same as those illustrated in FIGS. 3 to 7. An identifier is information for specifying data to be written, like in the first embodiment. Specifically, an identifier indicates a name or various types of bit strings. Like in the first embodiment, an expiration date is sent from the controller 101 together with a write instruction, and may be normalized as needed. A storage destination address specifies a location on the volatile storage 102.

Examples of the predetermined condition include the first condition, the second condition, and the third condition which are described in the first embodiment.

### (Operation Sequence)

A series of processes using the volatile storage 102 are controlled by the controller 101. For example, a series of processes using the volatile storage 102 can be implemented as a part of the process of a file system or a device driver.

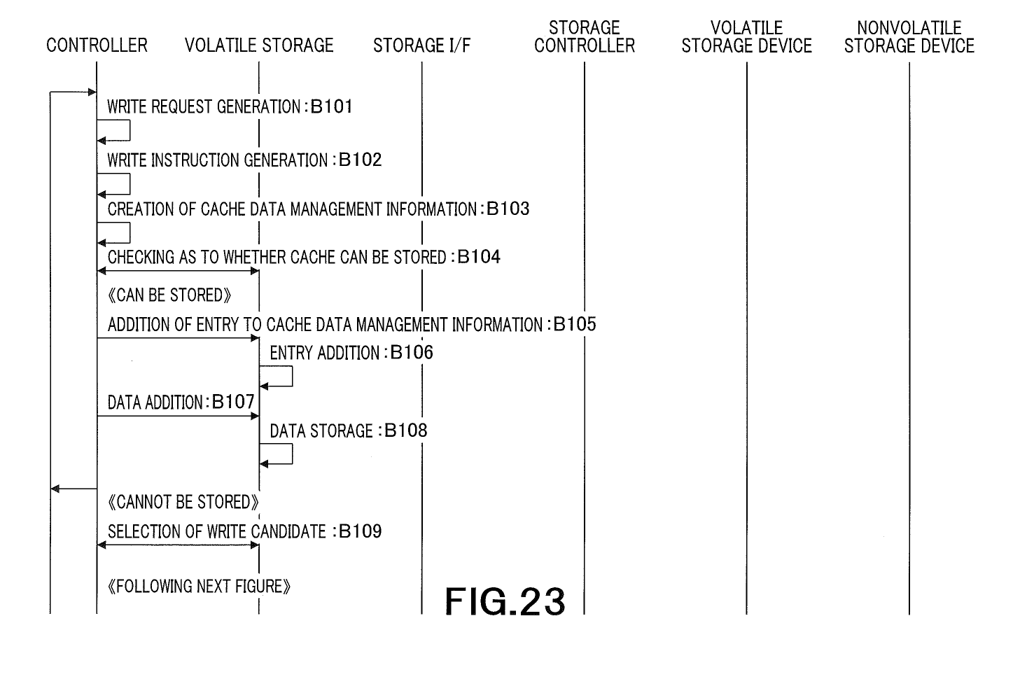

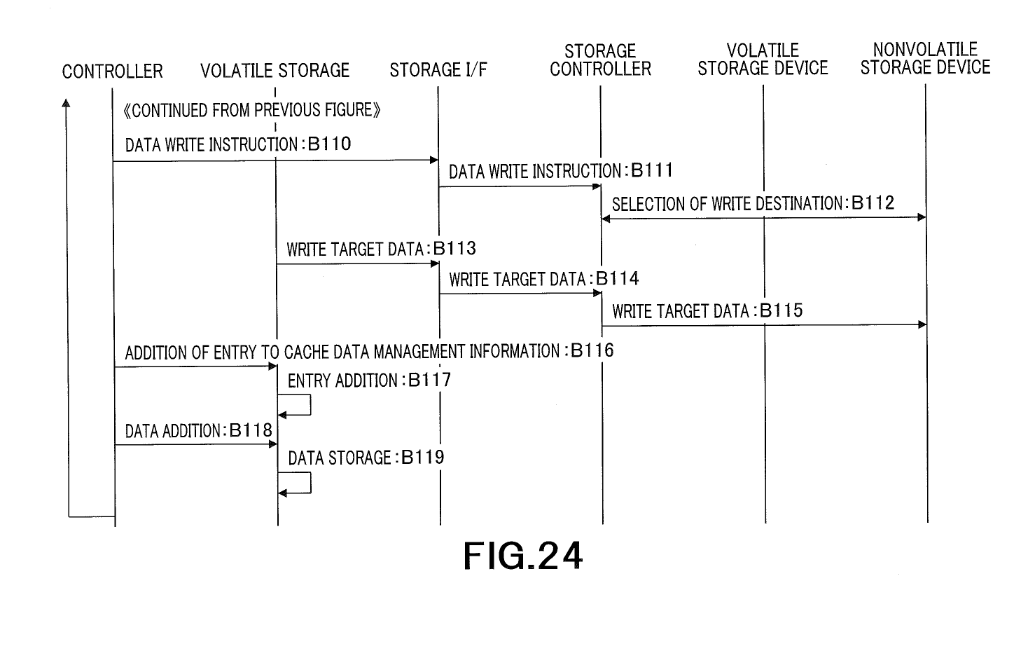

FIG. 23 is a sequence diagram of the second embodiment. FIG. 24 is a sequence diagram following FIG. 23. When the controller 101 receives a write request via the communication I/F 103 (B101), the controller 101 generates a write instruction (B102) and generates the cache data management information as needed (B103). The controller 101 determines whether it is possible to store data into the volatile storage 102 (B104). If it is possible to store data in the volatile storage 102, the controller 101 adds an entry to the cache data management information in the volatile storage 102 (B105, B106), and stores the data in the volatile storage 102 (B107, B108).

If it is impossible to store data in the volatile storage 102 (if there is no empty area or no free space), the controller 101 selects write candidate data in the volatile storage 102 (B109), and outputs the selected data write instruction to the storage controller 107 via the storage I/F 106 (B110 and B111 in FIG. 24). Further, the controller 101 sends data to be written to the storage controller 107 via the storage I/F 106 (B113, B114). The storage controller 107 selects the write destination in the nonvolatile storage device 109 (B112), and writes the data to be written (B115). Further, the controller 101 adds a new entry to the cache data management information in the volatile storage 102 (B116, B117), and writes (stores) new data into the volatile storage 102 (B118, B119).

### Second Embodiment: Modification

In the above example, write requests are integrated for each expiration date (or for each expiration date range) in the disk cache (volatile storage 102), and temporarily stores the data instructed to be written. On the other hand, the write requests can be integrated for each expiration date in an application, rather than in the volatile storage 102. This configuration can be applied to, for example, a cache server for web data and a cache server for database.

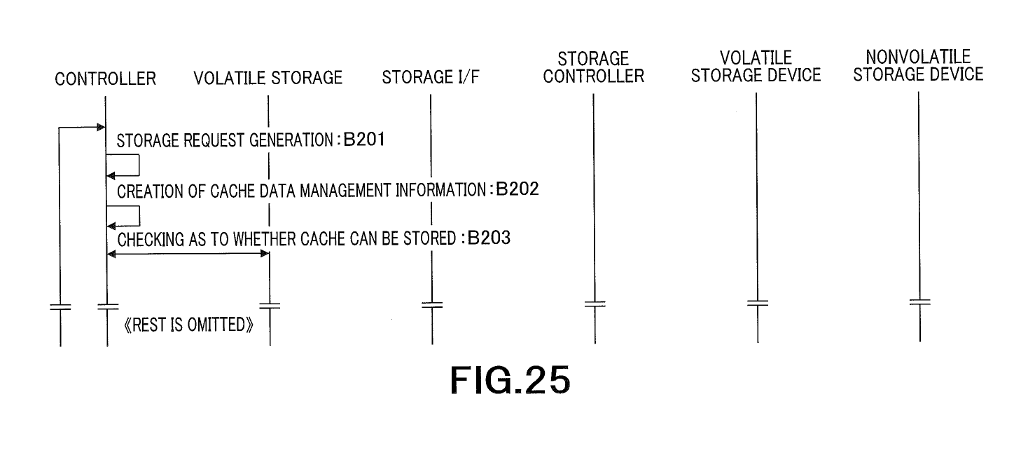

A functional block diagram in this modification is the same as the functional block diagram (FIG. 1) of the first embodiment. The sequence diagram in this modification is slightly changed. FIG. 25 shows changes in the sequences of FIGS. 23 and 24 described above.

When the volatile storage 102 functions as the above-mentioned disk cache, after a write request is generated, the controller 101 creates the write instruction and the content to be written is integrated for each expiration date based on the write instruction and cached in the volatile storage 102. On the other hand, in this modification, when a request for storing data into a buffer in which an application is secured is generated (B201), the process is started. This buffer corresponds to the volatile storage 102 in the series of explanations and is used to temporarily store the cache data management information and actual data.

The cache data management information is created as needed (B202), and the application checks whether it is possible to store the data according to the request (B203). If it is possible to store the data, the data is stored into a buffer, and if it is impossible to store the data, the data write instruction is output to the nonvolatile storage 105. The data write process is similar to that in the disk cache. Specifically, write candidate data is selected in the application and then an instruction to write the data into the nonvolatile storage 105 is generated.

### (Summary of Second Embodiment)

In the second embodiment, the data designated by the write instruction from the controller 101 is temporarily stored in the volatile storage 102 for each group of the expiration date, and the data with the same or close expiration dates are integrated and written into the nonvolatile storage 105. Specifically, the data is written by a size unit that enables efficient data write and update in the nonvolatile storage device 109. Thus, even when requests for writing small size of information are frequently made, an increase in the number of rewrite cycles can be suppressed while the write efficiency is maintained.

### Third Embodiment

In a third embodiment, instructions themselves (write instructions or read instructions) for the nonvolatile storage 105 are integrated, stored and managed by a storage controller disposed between the controller 101 and the nonvolatile storage 105 based on an expiration date. In general, the controller 101 controls a storage device (such as an SSD or HDD) corresponding to the nonvolatile storage 105 by using a protocol (such as AHCI or NVM Express) for controlling the storage. The third embodiment provides a function for integrating instructions (write instructions or read instructions) for each expiration date by the storage controller based on a level of a message to be exchanged according to the protocols.

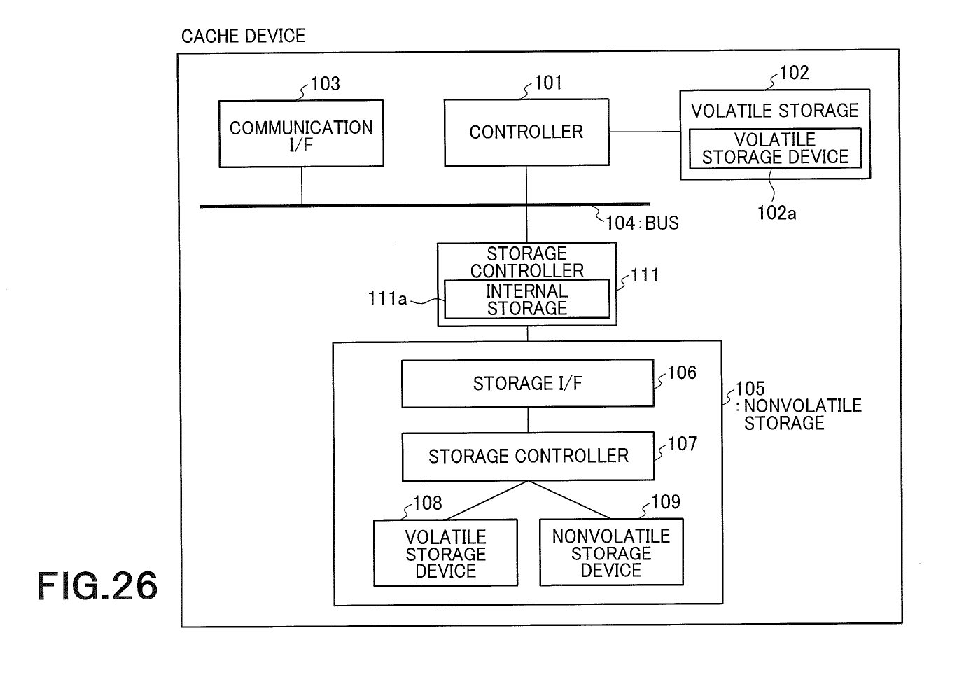

A cache device according to the third embodiment has a configuration in which a storage controller 111 is added to the cache device of the other embodiments. FIG. 26 shows a functional block diagram of the cache device according to the third embodiment. The elements having the same name as that in FIG. 1 are denoted by the same reference numerals, and repeated explanations thereof except for expanded or changed processes are omitted.

The storage controller 111 includes an internal storage 111a. The internal storage 111a can be formed of, for example, any memory or circuit. The storage controller 111 is a portion that receives an instruction from software that runs on the controller 101 and converts the instruction into a control command which can be interpreted by (the storage controller 107 of) the nonvolatile storage 105. In the conversion process by the storage controller 111, a function for integrating instructions for each expiration date according to the third embodiment is also executed. The storage controller 111 can be present in the cache device of the first and second embodiments, but the storage controller 111 is not relevant to the features of the first and second embodiments, and thus is omitted.

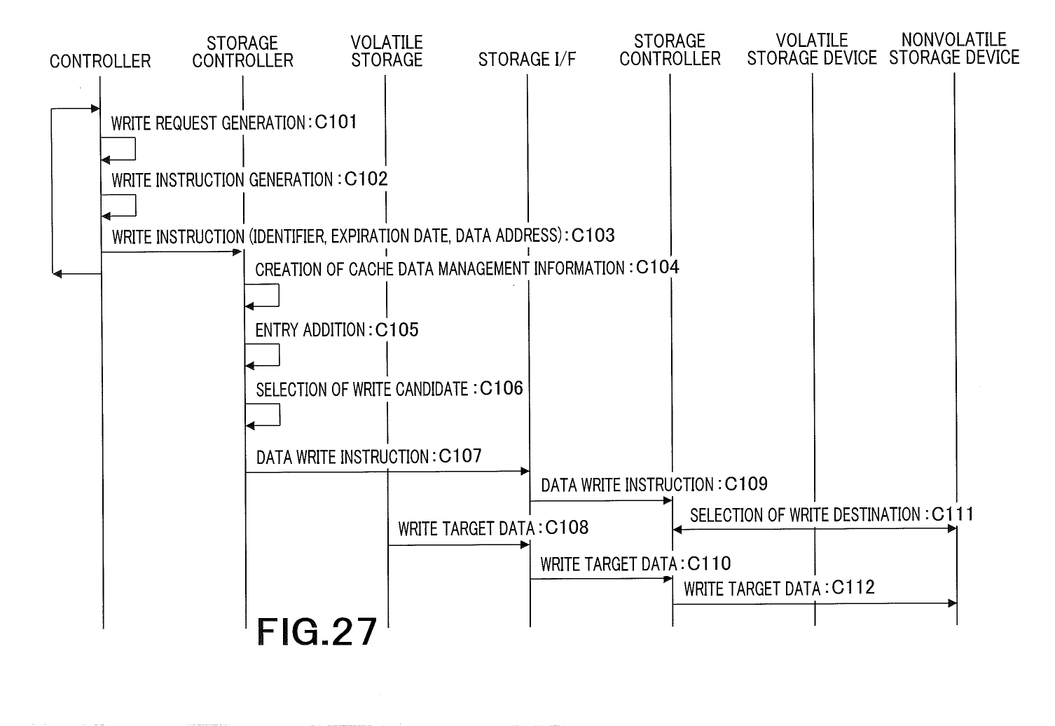

FIG. 27 shows a sequence diagram according to the third embodiment. The basic operation of the third embodiment is similar to that of the second embodiment, but they differ in the following respects.

A write instruction generated by the controller 101 is transmitted to the storage controller 111 (C103).

The storage controller 111 generates and manages the cache data management information (C104). In this case, the storage controller 111 does not provide the function for temporarily storing the data. Accordingly, an entry is added to the cache data management information without depending on the data size. The state of the empty area in the volatile storage 102 may be determined based on the content of the entry retained therein, and a timing for writing data into the nonvolatile storage device may be determined.

The storage controller 111 controls transfer of the data instructed to be written from the volatile storage 102 to the nonvolatile storage 105 (C107).

The other sequences (C101, C102, C105, C106, C108, C109, C110, C111, and C112) are the same as those of the second embodiment, and thus the descriptions thereof are omitted.

The identifier of the cache data management information is an identifier for specifying each message in a protocol for storage. In the write instruction received by the storage controller 111, the actual state of the data is not transferred, but instead only the address information of the volatile storage 102 in which the data is stored is sent from the controller 101. The storage controller 111 integrates write instructions based on the expiration date in a buffer provided therein, and when a predetermined condition is satisfied, the storage controller 111 issues an instruction to write data into the nonvolatile storage 105 to the volatile storage 102. In this case, the data is read from the volatile storage 102 and transferred to the nonvolatile storage 105.

When the storage controller 111 issues a write instruction to the nonvolatile storage 102, a write command according to an existing storage control protocol may be continuously issued, or a new command obtained by integrating a plurality of commands may be defined. Alternatively, only the instructed data may be integrated using an existing command and the integrated data may be written using the existing command.

To manage the establishment of the third condition among the three predetermined conditions illustrated in the first embodiment as conditions for writing data into the nonvolatile storage 105, a control using a timer may be introduced. In this case, the control may be implemented in such a manner that, if the expiration date (or the normalized expiration date) is divided by a plurality of thresholds, the timer is caused to operate in each area, and data may be written into the nonvolatile storage device 109 after a lapse of a predetermined time. With this configuration, the possibility that the data in the volatile storage device 108 may be lost due to unintended power discontinuity or the like can be reduced, although the usage efficiency of the nonvolatile storage 105 decreases.

### (Summary of Third Embodiment)

In the third embodiment, the internal storage 111a of the storage controller 111 temporarily stores the write instruction having the expiration date, and the data with close expiration dates are integrated. When the predetermined condition is satisfied, the data instructed by the write instruction to be written is selected based on the proximity of the expiration date (by integrating the data), and writes the data from the volatile storage 102 to the nonvolatile storage 105, thereby making it possible to effectively implement the operation. Since it is obvious that the other operations are similar to those of the first embodiment and effects similar to those of the first embodiment can be obtained, the descriptions of the operations are omitted. Further, since the storage controller 111 temporarily stores the write instruction, modifications for implementing more efficient operations, such as conversion of a write command, can be actively combined.

According to the cache device (data storage device) can also be realized, for example, by using a general purpose computer as basic hardware. Specifically, the functions of the device can be realized by causing a processor incorporated in the above computer device to execute the program. At this point, the device may be realized by installing in advance the above program on the computer. Alternatively, it may be realized by storing the program in a storage medium such as CD-ROM or distributing the program via a network, and thus installing this program on the computer device as appropriate. Also, the storage in the job delivery device can be realized by using as appropriate a memory built in or externally connected to the above computer device, hard disk, or a storage medium such as CD-R, CD-RW, DVD-RAM, and DVD-R.

The terms used in this embodiment should be construed in their broad senses. For example, the term “processor” may encompass a general purpose processor, a central processing unit (CPU), a microprocessor, a digital signal processor (DSP), a controller, a microcontroller, a state device, and the like. The term “processor” may denote, depending on the situations, an application specific integrated circuit, a field programmable gate array (FPGA), a programmable logic device (PLD), and the like. The term “processor” may denote combination of microprocessors, combination of a DSP and a microprocessor, and one or more microprocessors that operates in cooperation with a DSP core.

As another example, the term “memory” or “storage” may encompass any appropriate electronic components that can store electronic information. “Memory” may denote a random access memory (RAM), a read-only memory (ROM), a programmable read-only memory (PROM), an erasable programmable read-only memory (EPROM), an electrically erasable PROM (EEPROM), a non-volatile random access memory (NVRAM), a flash memory, and a magnetic or optical data storage, which can be read by the processor. When the processor writes and/or reads information to/from the memory, it can be said that the memory carries out electrical communications with the processor. The memory may be integrated into the processor. It can be said in this case as well that the memory is carrying out electrical communications with the processor.

The present invention is not limited to the above-described embodiments as such and can be effectuated with various modifications made to the constituent components at the actual stage of implementation without departing from the scope of the present invention. Also, various inventions may be constructed by appropriate combination of the constituent components disclosed in the above embodiment. For example, some of the constituent components may be eliminated from the entire set of the constituent components presented in the context of the embodiments. Further, constituent components that pertain to different embodiments may be combined as appropriate.

1. A data storage device comprising:
a first hardware storage device;
a second hardware storage device in which write is done by an integer multiple size of a predetermined size; and
the data storage device being configured to
write data into the first hardware storage device in response to a write instruction of data having expiration information,
manage data management information including: the expiration information of data written into the first hardware storage device; and a storage location of the data, and
select, when a predetermined condition is satisfied, a plurality of pieces of data in the first hardware storage device based on temporal proximity among pieces of the expiration information, read out the pieces of data from the first hardware storage device, and write the pieces of data into the second hardware storage device.

2. The data storage device according to claim 1, wherein the data storage device is configured to select pieces of data having same or similar expiration information preferentially.

3. The data storage device according to claim 1, wherein the predetermined condition is that a total size of the data written into the first hardware storage device is equal to or more than an second integral multiple of the predetermined size.

4. The data storage device according to claim 1, wherein the data management information is stored in the first hardware storage device.

5. The data storage device according to claim 1, wherein the data storage device is configured to classify a plurality of pieces of the data management information by at least one threshold for an expiration into groups and manage the data management information per group.

6. The data storage device according to claim 5, wherein a first area is set in the first hardware storage device for each of groups, and the data is written into the first area corresponding to the group to which the data management information of the data belongs.

7. The data storage device according to claim 5, wherein the data storage device is configured to detect the group the expiration data corresponding to which has passed a time corresponding to the threshold and delete the data management information belonging to the detected group.

8. The data storage device according to claim 5, wherein a second area is set in the second hardware storage device for each of the groups and the data is written into the second area corresponding to the group to which the data management information of the data belongs.

9. The data storage device according to claim 1, wherein the data storage device is configured to normalize the expiration information to a predetermined time unit, and manage the data management information based on the normalized expiration information.

10. The data storage device according to claim 1, wherein the second hardware storage device are formed of a plurality of units, and the data storage device is configured to specify an area of units in which the data is to be written in the second hardware storage device based on the expiration information of the data and a number of rewrite cycles for each of unit areas in the second hardware storage device, the unit areas having an upper limit on a number of rewrite cycles.

11. The data storage device according to claim 10, wherein the number of rewrite cycles of the unit area is an average of the number of rewrite cycles of a plurality of storage elements included in the unit area.

12. The data storage device according to claim 1, wherein the second hardware storage device are formed of a plurality of units, and the data storage device is configured to calculate an evaluation value for each of unit areas based on the expiration information of data and a number of rewrite cycles for each of the unit areas in the second hardware storage device, and specify an area of units in which the data is to be written in the second hardware storage device based on the evaluation value.

13. The data storage device according to claim 5, wherein
the second hardware storage device are formed of a plurality of units,
the data storage device is configured to set a first area in the first hardware storage device for each of the groups and write the data into the first area corresponding to the group to which the data management information of the data belongs,
set a second area in the second hardware storage device for each of the groups and write the data into the second area corresponding to the group to which the data management information of the data belongs, and
change a correspondence between the plurality of groups and the plurality of second areas according to a number of rewrite cycles for each of unit areas in each of the plurality of second areas.

14. The data storage device according to claim 5, wherein
the data storage device is configured to set a first area in the first hardware storage device for each of the groups and writes the data into the first area corresponding to the group to which the data management information of the data belongs,
the second hardware storage device includes a plurality of storage devices having different properties, the plurality of storage devices respectively corresponding to the plurality of groups, and
writes the data into the storage device corresponding to the group to which the data management information of the data belongs.

15. The data storage device according to claim 1, wherein
the first hardware storage device is a volatile storage device, and
the second hardware storage device is a nonvolatile storage device.

16. The data storage device according to claim 1, further comprising:
a storage controlling circuitry configured to control the first hardware storage device and the second hardware storage device; and
a storage I/F configured to acquire a write instruction of data having the expiration information via a bus, wherein
the storage controlling circuitry is configured to
write the data into the first hardware storage device based on the write instruction,
manage data management information including: the expiration information of data written in the first hardware storage device; and a storage location of the data and
select, when a predetermined condition is satisfied, a plurality of pieces of data in the first hardware storage device based on temporal proximity among pieces of the expiration information, read out the pieces of data from the first hardware storage device, and write the pieces of data into the second hardware storage device.

17. The data storage device according to claim 1, further comprising:
a first storage including the first hardware storage device;
a second storage including the second hardware storage device;
a controlling circuitry; and
a bus, wherein
the controlling circuitry and the second storage are connected via the bus, and the first storage is connected to the controlling circuitry via the bus or not via the bus, and
the controlling circuitry is configured to
generate the write instruction of data for the first storage to write data into the first storage,
manage data management information including: the expiration information of data written in the first storage; and a storage location of the data, and
select, when a predetermined condition is satisfied, a plurality of pieces of data in the first hardware storage device based on temporal proximity among pieces of the expiration information, read out the pieces of data from the first hardware storage device, and write the pieces of data into the second hardware storage device.

18. The data storage device according to claim 1, further comprising:
a controlling circuitry;
a storage controlling circuitry; and
a bus, wherein
the controlling circuitry, the second storage, and the storage controlling circuitry are each connected to the bus, and the first storage is connected to the controlling circuitry via the bus or not via the bus, and
the controlling circuitry is configured to generate the write instruction of data to write data into the first storage;
the storage controlling circuitry comprises an internal storage configured to temporarily store a plurality of write instructions; and is configured to select, when a predetermined condition is satisfied, a plurality of pieces of data in the first hardware storage device based on temporal proximity among pieces of the expiration information, read out the pieces of data from the first hardware storage device, and write the pieces of data into the second hardware storage device.

19. A data storage method comprising:
writing data into a first hardware storage device in response to a write instruction of data having expiration information;
managing data management information including: the expiration information of data written into the first hardware storage device; and a storage location of the data; and
selecting, when a predetermined condition is satisfied, a plurality of pieces of data in the first hardware storage device based on temporal proximity among pieces of the expiration information, reading out the pieces of data from the first hardware storage device, and writing the pieces of data into a second hardware storage device in which write is done by an integer multiple size of a predetermined size.

20. A non-transitory computer readable medium having a computer program stored therein which when executed by a computer, causes the computer to perform processes comprising:
writing data into a first hardware storage device in response to a write instruction of data having expiration information;
managing data management information including: the expiration information of data written into the first hardware storage device; and a storage location of the data; and
selecting, when a predetermined condition is satisfied, a plurality of pieces of data in the first hardware storage device based on temporal proximity among pieces of the expiration information, reading out the pieces of data from the first hardware storage device, and writing the pieces of data into a second hardware storage device in which write is done by an integer multiple size of a predetermined size.
